(19) United States
(12) Patent Application Publication
(10) Pub. No.: US 2025/0094925 A1
(43) Pub. Date: Mar. 20, 2025

(54) SYSTEM AND METHOD FOR E2E WORK ORDER MANAGEMENT FOR COVERAGE HOLE MITIGATION

(71) Applicant: RAKUTEN SYMPHONY, INC., Tokyo (JP)

(72) Inventors: Prithvi Raj DHAKA, Indore (IN); Prafull JOHRI, Indore (IN); Atul RAJPOOT, Indore (IN); Durgesh RATHORE, Indore (IN)

(21) Appl. No.: 17/998,808

(22) PCT Filed: Jul. 22, 2022
(86) PCT No.: PCT/US2022/037970

§ 371 Date: Nov. 15, 2022

(51) Int. Cl. G06Q 10/10; G06Q 10/0631

(52) U.S. Cl. CPC G06Q 10/103; G06Q 10/06311

(57) ABSTRACT

A method includes receiving a coverage hole mitigation work order (CHMWO) created by a project work order (PWO) administrator; receiving assignment of the CHMWO from the PWO administrator to a PWO requester that is included in a geographic location of the CHMWO; receiving coverage hole optimization for the CHMWO from the PWO requester; and closing the CHMWO in response to the coverage hole optimization being validated.

### TECHNICAL FIELD

This description relates to an E2E work order management for coverage hole mitigation system and method of using the same.

### BACKGROUND

A cellular network is a telecommunication system of mobile devices (e.g., mobile phone devices) that communicate by radio waves through one or more local antenna at a cellular base station (e.g., cell tower). The coverage area in which service is provided is divided into small geographical areas called “cells”. Each cell is served by a separate low power multichannel transceiver and antenna at the cell tower. Mobile devices within a cell communicate through that cell's antenna on multiple frequencies and on separate frequency channels assigned by the base station from a common pool of frequencies used by the cellular network.

A radio access network (RAN) is part of the telecommunication system and implements radio access technology. RANs reside between a device such as a mobile phone, a computer, or remotely controlled machine and provides connection with a core network (CN). Depending on the standard, mobile phones and other wireless connected devices are varyingly known as user equipment (UE), terminal equipment, mobile station (MS), and the like.

### SUMMARY

In some embodiments, a method includes receiving a coverage hole mitigation work order (CHMWO) created by a project work order (PWO) administrator; receiving assignment of the CHMWO from the PWO administrator to a PWO requester that is included in a geographic location of the CHMWO; receiving coverage hole optimization for the CHMWO from the PWO requester; and closing the CHMWO in response to the coverage hole optimization being validated.

In some embodiments, an apparatus, includes a processor; and a memory having instructions stored thereon that, when executed by the processor, cause the processor to receive a coverage hole mitigation work order (CHMWO) created by a project work order (PWO) administrator; receive assignment of the CHMWO from the PWO administrator to a PWO requester that is included in a geographic region of the CHMWO; receive coverage hole optimization for the CHMWO from the PWO requester; and close the CHMWO in response to the coverage hole optimization being validated.

In some embodiments, a non-transitory computer readable medium having instructions stored thereon that, when executed by a processor, cause an apparatus to receive a coverage hole mitigation work order (CHMWO) created by a project work order (PWO) administrator; receive assignment of the CHMWO from the PWO administrator to a PWO requester that is included in a geographic region of the CHMWO; receive coverage hole optimization for the CHMWO from the PWO requester; and close the CHMWO in response to the coverage hole optimization being validated.

### BRIEF DESCRIPTION OF THE DRAWINGS

Aspects of the present disclosure are understood from the following detailed description when read with the accompanying FIGS. In accordance with the standard practice in the industry, various features are not drawn to scale. In some embodiments, dimensions of the various features are arbitrarily increased or reduced for clarity of discussion.

FIG. 1 is a diagrammatic representation of a system for coverage hole mitigation (CHM) through end-to-end (E2E) work order (WO) management, in accordance with some embodiments.

FIG. 2 is a data flow diagram of a CHM module, in accordance with some embodiments.

FIG. 3 is a pictorial representation of a graphical user interface (GUI) of a geographic area with a polygon pattern displayed on a user interface (UI), in accordance with some embodiments.

FIG. 4 is a pictorial representation of a GUI for creation of a CHMWO displayed on a UI, in accordance with some embodiments.

FIG. 5 is a pictorial representation of a GUI for creation of a CHMWO displayed on a UI, in accordance with some embodiments.

FIG. 6 is a pictorial representation of a GUI CHMWO homepage displayed on a UI, in accordance with some embodiments.

FIGS. 7A and 7B are flow diagram representations of a method for creating a CHMWO, in accordance with some embodiments.

FIGS. 8-28 are pictorial representations of GUIs for creation of a CHMWO displayed on a UI, in accordance with some embodiments.

FIG. 29 is a high-level functional block diagram of a processor-based system, in accordance with some embodiments.

### DETAILED DESCRIPTION

The following disclosure provides many different embodiments, or examples, for implementing different features of the discussed subject matter. Examples of components, values, operations, materials, arrangements, or the like, are described below to simplify the present disclosure. These are, of course, examples and are unintended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to be in direct contact. In addition, the present disclosure repeats reference numerals and/or letters in the various examples. This repetition is for the purpose of simplicity and clarity and is unintended to dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, a system and method for coverage hole mitigation (CHM) through an end-to-end (E2E) work order (WO) is disclosed in accordance with embodiments of the present disclosure. E2E describes a process that takes a system or service from beginning to end and delivers a complete functional solution, usually without needing to obtain anything from a third party.

A WO is a task or a job that is scheduled or assigned to someone. Such an order includes a customer request or request created internally within an organization. WOs are further created as a follow up to inspections or audits. A WO includes one or more of the following: instructions, cost estimates, forms, date, and time to execute the WO, information about the location and entities to execute the WO, and a person to whom the WO is assigned. In a service environment, a WO is equivalent to a service order where the WO records the location, date, and time the service is carried out and the nature of work that is done. The type of personnel (e.g., job position) is further listed on the WO. The total number of hours worked, and total value is further shown on the WO. In some embodiments, a WO is a maintenance or repair request. In some embodiments, a WO is an internal document extensively used by projects-based businesses (e.g., project WOs).

In other approaches, several engineers perform the optimization of thousands of coverage holes in a network. A coverage hole is a region where the received signal level of the serving cell and other neighbor cells is below the levels required to maintain the service under a minimum level of quality and robust radio performance. Currently there is no monitoring of whether coverage hole optimization is effective. Engineers and vendors work close to optimize coverage holes within an agreed service level agreement (SLA). Manually tracking improvement of coverage hole optimization of a particular geography is unrealistic.

In some embodiments, E2E WO management is configured to provide solutions to CHM in a sequential manner by creating WOs of coverage holes. In CHM WOs suggest changes to existing parameter values like electrical tilt (e-tilt is defined as the angular shift in elevation of the direction of maximum gain of the antenna by a specific electrical design of the antenna; either fixed or variable.), mechanical tilt (m-tilt—with mechanical tilt, the coverage area is reduced in a central direction, but the coverage area of side directions is increased and with electrical tilt the coverage area realizes a uniform reduction in the direction of the antenna azimuth, that is, the gain is reduced uniformly), antenna height, or recommending a new site on a poor coverage area as well as the continuous monitoring of the performance of the impacted area (e.g., the CH). In some embodiments, there are tasks available in the CHMWO and are performed by a project work order (PWO) requester, PWO approver, and PWO administrator of a particular sales cluster (e.g., a certain geographic area).

In some embodiments, E2E monitoring is performed automatically by a CHM system. WOs are generated automatically and assigned to a respective engineer followed by their level (e.g., level 1 (L1), level 2 (L2)) approvals which ensure that optimization is performed according to established processes and each change in a network parameter is being recorded to keep the master inventory up to date.

In some embodiments, the CHMWO framework is as follows: a CHMWO creation, WO approved by the PWO administrator, the PWO administrator assigns the WO to a PWO requestor, execution of the WOs by the PWO requester and the PWO approver.

In some embodiments, CHMWO creation begins when a PWO administrator, having access, creates a CHMWO. The PWO administrator creates the WO and assigns the WO to a PWO requester of the district which falls within a geography of the PWO administrator. For each coverage hole, a separate WO is created. WO creation is performed for each district of a city.

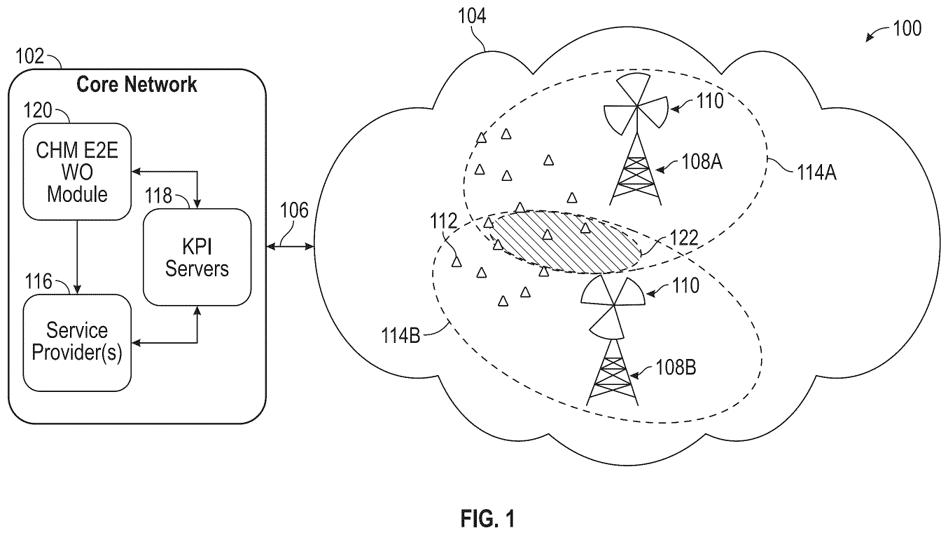

FIG. 1 is a diagrammatic representation of a system for coverage hole mitigation (CHM) through end-to-end (E2E) work order (WO) management 100, in accordance with some embodiments.

CHMWO system 100 includes a CN 102 communicatively connected to RAN 104 through backhaul 106, which is communicatively connected to base stations 108A and 108B (hereinafter base station 108), with antennas 110 that are wirelessly connected to UEs 112 located in geographic coverage cells 114A and 114B (hereinafter geographic coverage cells 114). Coverage holes, such as coverage holes 122, exist in locations where geographic coverage cells 114 overlap, one or more antenna 110 are misaligned, one or more cells 114 are overshooting, or there is a need for additional cells. CN 102 includes one or more service provider(s) 116, KPI servers 118, and CHM E2E WO module 120.

CN 102 (further known as a backbone) is a part of a computer network which interconnects networks, providing a path for the exchange of information between different local area networks (LANs) or subnetworks. In some embodiments, CN 102 ties together diverse networks over wide geographic areas, in different buildings in a campus environment, or in the same building.

In some embodiments, RAN 104 is a global system for mobile communications (GSM) RAN, a GSM/EDGE RAN, a universal mobile telecommunications system (UMTS) RAN (UTRAN), an evolved UMTS terrestrial radio access network (E-UTRAN), open RAN (O-RAN), or cloud-RAN (C-RAN). RAN 104 resides between UE 112 (e.g., mobile phone, a computer, or any remotely controlled machine) and CN 102. In some embodiments, RAN 104 is a C-RAN for purposes of simplified representation and discussion. In some embodiments, base band units (BBU) replace the C-RAN.

In conventional distributed cellular networks, equipment at the bottom and top of a base station of a cell site is the BBU. The BBU is radio equipment that links UEs to the CN and processes billions of bits of information per hour. The BBU was traditionally placed in an enclosure or shelter situated at the bottom of a base station. C-RAN, in contrast, uses fiber optic's large signal-carrying capacity to centralize numerous BBUs at a dedicated pool location or a base station. This reduces the quantity of equipment at base stations and provides many other advantages, including lower latency.

In a hierarchical telecommunications network, backhaul portion 106 of CHMWO system 100 includes the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul generally refers to the side of the network that communicates with the Internet. The connection between base station 108 and UE 112 begins with backhaul 106 connected to CN 102. In some embodiments, backhaul 106 includes wired, fiber optic, and wireless components. Wireless sections include using microwave bands, mesh, and edge network topologies that use high-capacity wireless channels to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers (transceivers), digital signal processors, control electronics, a remote radio head (RRH), primary and backup electrical power sources, and sheltering. Base stations are known by other names such as base transceiver station, mobile phone mast, or cell tower. In some embodiments, base stations are replaced with other edge devices configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90°, or 120° designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties. In some embodiments, the antenna(s) 110 are MIMO (multiple-input, multiple-output) antennas that send and receive greater than one data signal simultaneously over the same radio channel by exploiting multipath propagation.

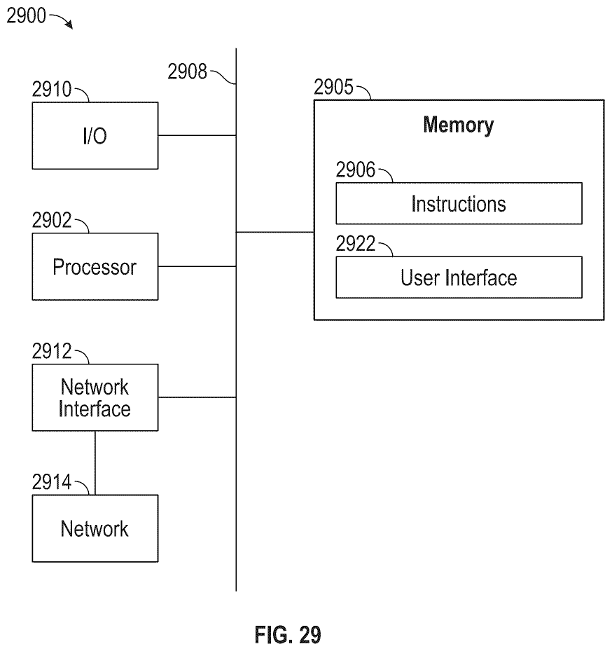

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 2922 (FIG. 29), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile Internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In some embodiments, geographic coverage cells 114 include a shape and size. In some embodiments, geographic coverage cells 114 are a macro-cell (covering 1 Km-30 Km), a micro-cell (covering 200 m-2 Km), or a pico-cell (covering 4 m-200 m). In some embodiments, geographic coverage cells are circular, oval (FIG. 1), sector, or lobed in shape, but geographic coverage cells 114 are configured in most any shape or size. Geographic coverage cells 114 represent the geographic area antenna 110 and UEs 112 are configured to communicate. Coverage depends on several factors, such as orography (i.e., mountains) and buildings, technology, radio frequency and perhaps most importantly for two-way telecommunications the sensitivity and transmit efficiency of UE 112. Some frequencies provide better regional coverage, while other frequencies penetrate better through obstacles, such as buildings in cities. The ability of a UE to connect to a base station depends on the strength of the signal. Coverage holes are caused by most anything such as faulty equipment, bad weather, animals, accidents, and the like. Coverage holes occur through the loss of one or more sets of transceivers, digital signal processors, control electronics, GPS receivers, primary and backup electrical power sources, and antennas. Additionally, or alternatively, coverage holes exist because areas were never previously covered by cellular service or created by removal of a cell tower or the like. In some embodiments, coverage holes develop after the service covering an area is lost for any reason. In other examples, a coverage hole is any area without any cell coverage service to user 112 for whatever reason.

Service provider(s) 116 are businesses, vendors, customers, or organizations that sell bandwidth or network access to subscribers (utilizing UEs) by providing direct Internet backbone access to Internet service providers and usually access to network access points (NAPs). Service providers are sometimes referred to as backbone providers, Internet providers, or vendors. Service providers include telecommunications companies, data carriers, wireless communications providers, Internet service providers, and cable television operators offering high-speed Internet access.

KPI servers 118 produce both predictions and live network data. Live-network data (KPIs, UE/cell/MDT (minimization of drive test) traces, and crowdsourced data) that allows for modelling of network traffic, hot-spot identification, and radio signal propagation. RF drive testing is a method of measuring and assessing the coverage, capacity, and Quality of Service (QoS) of a mobile radio network, such as RAN 104. The technique consists of using a motor vehicle containing mobile radio network air interface measurement equipment that detects and records a wide variety of the physical and virtual parameters of mobile cellular service in each geographical area. By measuring what a wireless network subscriber experiences in an area, wireless carriers make directed changes to networks that provide better coverage and service to customers. Drive testing commonly is configured with a mobile vehicle outfitted with drive testing measurement equipment. The equipment is usually highly specialized electronic devices that interface to original equipment manufacturer (OEM) mobile handsets (UEs). This ensures measurements are realistic and comparable to actual user experiences. For mobile networks, crowdsourcing methodology leverages a crowd of participants (e.g., the mobile subscribers) to gather network measurements, either manually or automatically through mobile apps, or directly from the network using call traces.

UE/cell/MDT traces collected at the operations support systems (OSS) or through dedicated tools provide service provider(s) 116 with user-level information. Once geo-located, UE/cell/MDT traces are used to enhance path-loss calculations and prediction plots, as well as to identify and locate problem areas and traffic hotspots. KPI servers 118 allow service provider(s) 116 to use UE/cell/MDT traces along with CHM E2E WO module 120 for network optimization.

In some embodiments, CHM E2E WO module 120 is configured to user E2E WO management to provide solutions to CHM in a sequential manner by creating CHMWOs. CHMWOs suggest changes to existing parameter values like e-tilt, m-tilt, antenna height, and/or a new cell site on a poor coverage area as well as the continuous monitoring of the performance of the impacted area (e.g., the coverage hole).

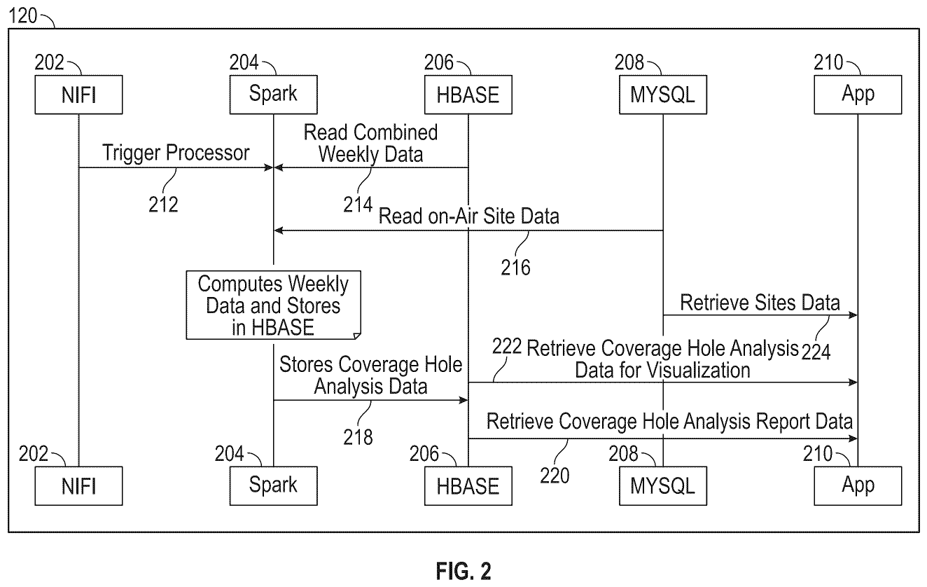

FIG. 2 is a data flow diagram of a CHM E2E WO module 120, in accordance with some embodiments.

CHM E2E WO module 120 includes a NIFI component 202, a Spark component 204, an Hbase-component 206, a MySQL component 208, and an Application component 210.

In some embodiments, NIFI-component 202 automates the flow of data between CHM E2E WO module 120 and KPI servers 118. NIFI-component 202 ingests data from third party applications, the data including latitude and longitude for each base station, such as base stations 108, frequency band details, eNB ID, E-UTRAN global identifier (ECGI), drive test data, KPIs, and other suitable data in accordance with some embodiments. In some embodiments, NIFI-component 202 is an open-source platform based on the concept of extract, transform, and load. The software design is based on the flow-based programming model and offers features that include the ability to operate within clusters, security using transport layer security (TLS) encryption, extensibility (e.g., users write their own software to extend abilities) and improved usability features like a portal which is used to view and modify behavior visually. NIFI-component 202 is used to schedule jobs, trigger flow, and ingest data from third-party applications like raw files from KPI servers 118.

Spark-component 204 is an open-source unified analytics engine for large-scale data processing. Spark-component 204 provides an interface for programming entire server clusters with implicit data parallelism and fault tolerance. Spark-component 204 is a parallel processing framework for running large-scale data analytics applications across clustered computers. Spark-component 204 handles both batch and real-time analytics and data processing workloads.

Hbase-component 206 provides a fault-tolerant way of storing large quantities of sparse data (e.g., small amounts of information caught within a large collection of empty or unimportant data). Hbase-component 206 is a column-oriented non-relational database management system that runs on top of a Hadoop Distributed File System (HDFS). HBase provides a fault-tolerant way of storing sparse data sets, which are common in many large data use cases.

HDFS-component (not shown) is a distributed filesystem that stores data on commodity machines, providing high aggregate bandwidth across server clusters. All batched data sources are initially stored into an HDFS-component and then processed using Spark-component 204. Hbase-component 206 further utilizes HDFS as data storage infrastructure.

MySQL-component 208 is an open-source relational database management system (RDBMS). A relational database organizes data into one or more data tables in which data types are related to each other and these relations help structure the data. MySQL component 208 creates, modifies, and extracts data from Spark-component 204 at operation 216, as well as controls user access. MySQL-component 208 is utilized for application programming interface (API) retrieval and for serving any real-time user interface (UI), such as UI 2922 (FIG. 29). The aggregated and correlated data is further stored in MySQL.

Application component 210 allows a user, through a UI, such as UI 2922 of FIG. 29, to visualize the coverage hole identification (e.g., retrieve coverage hole analysis data for visualization) at operation 222. A user visualizes varying aspects of CHM in real time including coverage hole analysis report data at operation 220. In some embodiments, a user visualizes coverage holes over specified bands and varying geographic areas. In some embodiments, a user visualizes individual grids (e.g., 50-meter×50-meter geographic areas) based on a coverage hole analysis. For example, a user determines whether a grid (e.g., a 50-meter×50-meter geographic area) is experiencing poor coverage, whether any non-serving cell within the grid is a critical interferer cell, whether the grid has a clearly dominate server cell, whether any non-serving cell has an interferer warning, or whether the internal interference is a handover area.

In some embodiments, a user drills down into details within the grid. In some embodiments, a user hovers over or clicks on a grid and a pop-up box reveals information such as cell ID, cell reference signal received power (RSRP is a measurement of the received power level in an LTE cell network. The average power is a measurement of the power received from a single reference signal.), cell median RSRP, cell reference signal received quality (RSRQ is the ratio of the carrier power to the interference power: essentially this is a signal-noise ratio measured using a standard signal), and the number of cells within the grid.

At operation 212, spark component 204 retrieves third party data from NIFI component 202. In some embodiments, the inputted third-party data includes site information from a site database, such as a latitude and longitude of all cells in a RAN, frequency band details, eNB ID, ECGI, and other suitable information. In some embodiments, the inputted data additionally includes geo-located data, such as RF drive testing information, UE KPI data or other passively collected data. In some embodiments, the geo-located data is collected over a continually running window of time, such as seven days. In some embodiments, the geo-located data is collected over greater than seven days and in some embodiments the geo-located data is collected over less than seven days. In some embodiments, the window of time for collection of geo-located data is controlled by a sliding window algorithm. In some embodiments, the collected data is collected in a FIFO (first in, first out) manner whereas new data is collected older data is removed (e.g., data greater than seven days old).

Spark component 204 stores the geo-located data in Hbase component 206 and retrieves the stored data at operation 214 to perform a coverage hole analysis. At operation 218, Spark component 204 stores the coverage hole analysis in Hbase component 206. Continuing with operation 216, MySQL 208 retrieves site information from Spark component 204 and combines the site information for Application 210. Application 210, at operation 222, retrieves the coverage hole analysis data from Hbase component 206 for visualization. Application component 210 further retrieves interference analysis report data at operation 220 for visualization.

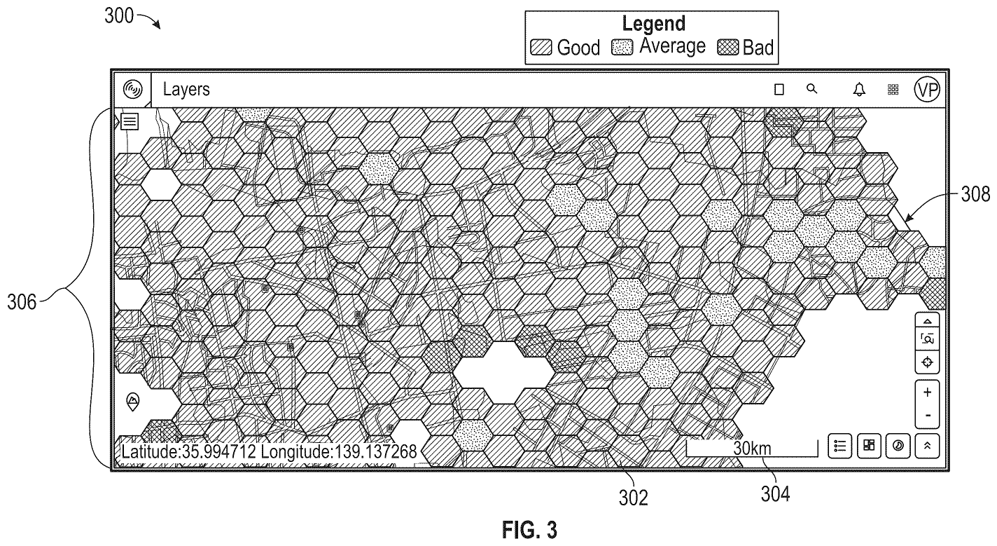

FIG. 3 is a pictorial representation of a graphical user interface (GUI) 300 of a geographic area with a polygon pattern 302 displayed on a user interface (UI), in accordance with some embodiments.

Network visualization geographic area GUI 300 is a representation of the collected data presented by the application discussed above. Network visualization geographic area GUI 300 is divided into polygons 302 where, in some embodiments, each polygon 302 represents a geographic area based on scale 304 of network visualization geographic area GUI 300. Network visualization geographic area GUI 300 includes polygons 302 that are layered over map 308, which represents a geographic area of interest. In some embodiments, the polygons 302 combine to form a polygon pattern 306. In some embodiments, polygons 302 are configured with varying sizes and provide information relating to network coverage quality (e.g., as good, average, or bad). In some embodiments, polygons indicated as average or bad are geographic areas that include one or more coverage holes. In some embodiments, the size of polygons 302 are adjustable by an engineer or user. In some embodiments, polygons 302 have varying shapes including circular, square (like the 50-meter×50-meter grids discussed above), and rectangular. In some embodiments, a user selects an alternate shape for polygons 302. In some embodiments, the area of polygons 302 are based on a level of zoom into network visualization geographic area GUI 300.

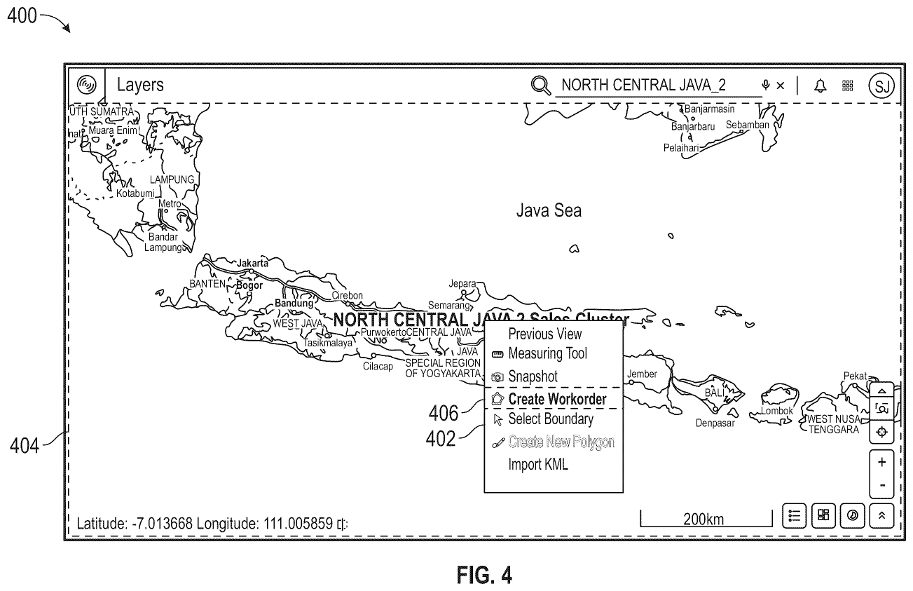

FIG. 4 is a pictorial representation of a GUI 400 for creation of a CHMWO displayed on a UI, in accordance with some embodiments.

CHWO creation is configured to be implemented on GUI 400 of a UI, such as UI 2922 (FIG. 29). A PWO administrator with appropriate access creates a CHMWO by performing a right click operation to display context menu 402. Context menu 402 (also called contextual, shortcut, and pop up or pop-up menu) is a menu in GUI 400 that appears upon user interaction, such as a right-click mouse operation. A context menu offers a set of choices (e.g., previous view, measuring tool, snapshot, create workorder, select boundary, create new polygon, import KML (keyhole markup language is an XML notation for expressing geographic annotation and visualization within two-dimensional maps and three-dimensional Earth browser), or other options within the scope of the embodiments) that are available in the current state, or context, of the operating system or application to which the menu belongs. Usually, the available choices are actions related to the selected object. From a technical point of view, such a context menu is a graphical control element.

In response to the PWO administrator selecting the geographic area 404 (e.g., north central Java). A create work order option 406 is displayed in response to the PWO administrator right-clicking on geographic area 404 displayed on GUI 400.

In some embodiments, on clicking create workorder option 406, a pop-up window opens displaying one or more different options. In some embodiments, the PWO administrator creates the WOs and assigns one or more WOs to a PWO requester of each district which is included in the geography of the PWO administrator. In some embodiments, for each coverage hole, a separate WO is created. In some embodiments, WO creation is performed for each district of a city.

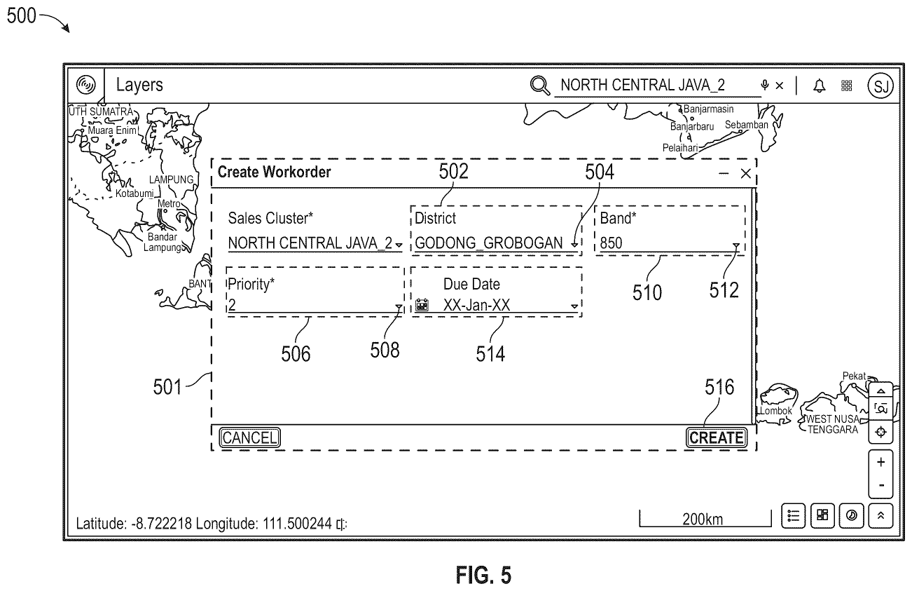

FIG. 5 is a pictorial representation of a GUI 500 for creation of a CHMWO displayed on a UI, in accordance with some embodiments.

In some embodiments, context menu 501 is configured to allow a user to input parameters during creation of the CHMWO. In some embodiments, a city name is selected in a drop-down window and the city name is greyed out. A drop-down list (abbreviated drop-down, or DDL; also known as a drop-down menu, drop menu, pull-down list, picklist, or other suitable name within the scope of the embodiments) is a graphical control element, like a list box, that allows the user to choose one value from a list. When a drop-down list is inactive, the drop-down list displays a single value. When activated, the drop-down list displays (e.g., drops down) a list of values, from which a user selects one. When the user selects a new value, the control reverts to an inactive state, displaying the selected value.

A user selects a district name 502 from district drop-down 504 for which the WO is to be created. The user selects a priority 506 from priority drop-down 508. The user creates WOs of priority P1/P2/P3 based on the coverage hole. In some embodiments, priority for each coverage hole available is displayed in the dropdown 508 for the selected district. In some embodiments, a P1 priority is selected for a high-usage cell, a P2 priority for a medium-usage cell, and a P3 priority for a low-usage cell.

The user selects from all available bands 510 shown in dropdown 512. Band selection is useful for creating the CHMWO. In some embodiments, the user selects from 850 MHz, 2300 MHz, or a suitable frequency at which the coverage hole is occurring within embodiments of the present disclosure. While creating a WO, the user selects a due date 514 for the WO. In some embodiments, the due date is the date that the WO is expected to be executed. In some embodiments, the due date is the date that the WO is expected to be competed. In some embodiments, the due date, by default, is 15 days from the creation date of the WO and is automatically selected. In some embodiments, the user selects an additional 30 days for executing the WO.

In some embodiments, after selecting the WO parameters in content menu 501 and clicking a create user input field 516, a pop-up message is presented (e.g., work order count is in progress where count is the number of WOs).

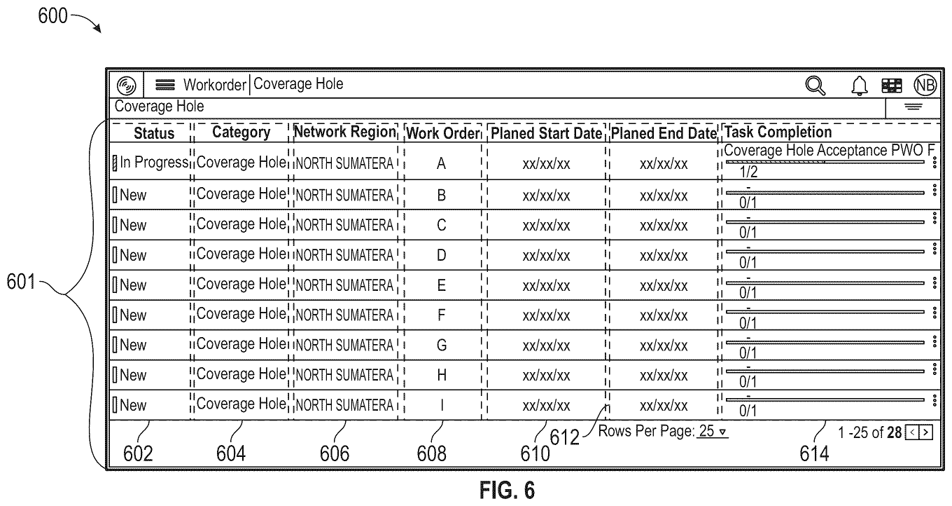

FIG. 6 is a pictorial representation of a GUI CHMWO homepage 600 displayed on a UI, in accordance with some embodiments.

CHMWO homepage 600 displays a list of CHMWOs 601. CHMWO homepage 600 includes columns such as status 602, category 604, network region 606, workorder 608, planned start date 610, planned end date 612, and task completion 614.

Status column 602 displays a status of each WO on homepage 600. In some embodiments, each WO is configured to include a status of new, in progress, at risk, and completed. Category column 604 displays a category of the WO (e.g., for the WOs the category is coverage hole). Network region column 606 displays a network region name for each coverage hole. WO column 608 displays a WO identification for each coverage hole for which a WO is created. Planned start date column 610 displays a WO creation date. Planned end date column 612 displays a due date for each WO. Task completion column 614 displays an ongoing task completion status.

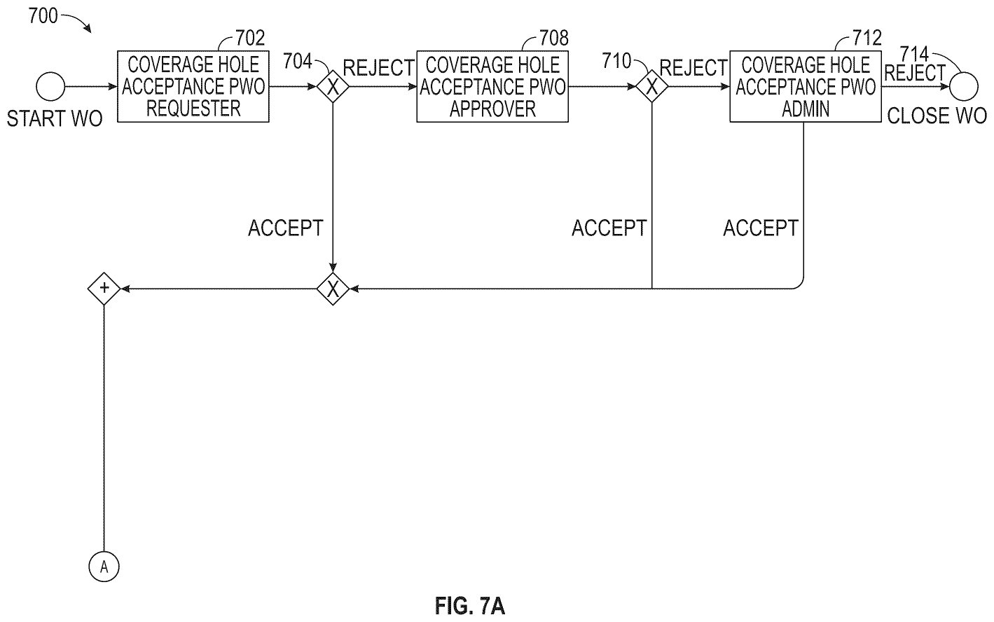

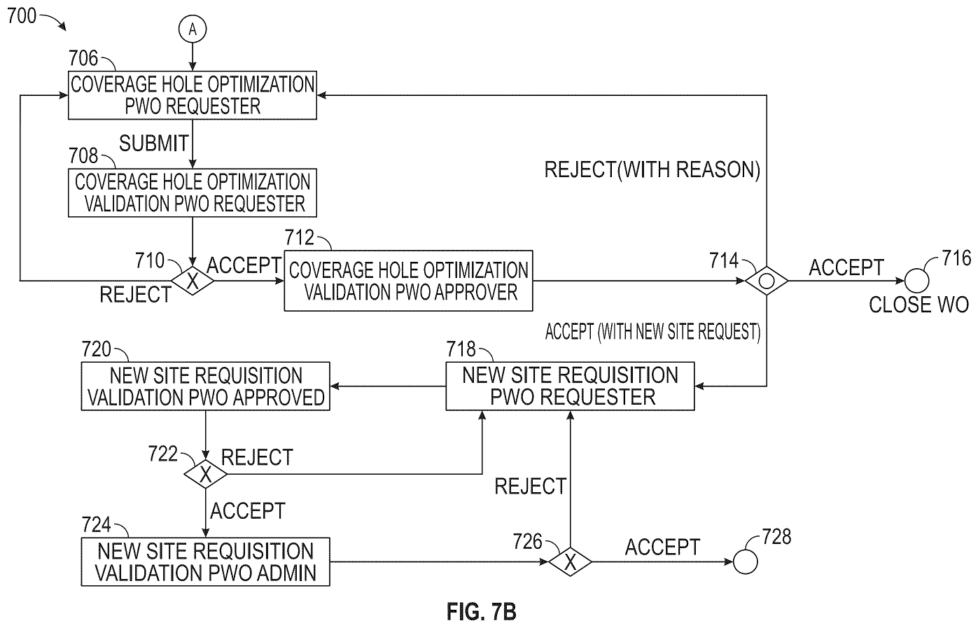

FIGS. 7A and 7B are flow diagram representations of a method for creating a CHMWO 700, in accordance with some embodiments.

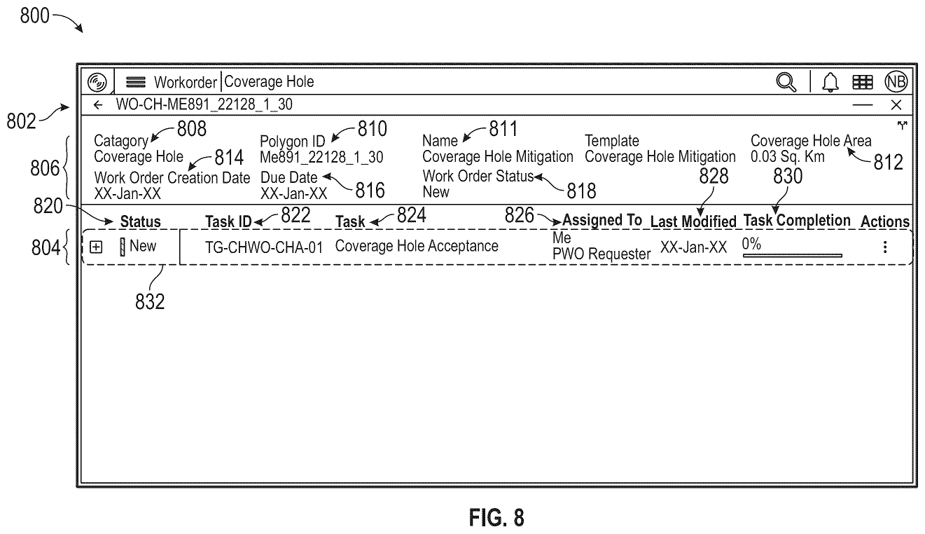

FIGS. 8-28 are CHMWO creation graphical user interfaces 800-2800, in accordance with some embodiments.

While the operations of method 700 are discussed and shown as having a particular order, each operation in method 700 is configured to be performed in any order unless specifically called out otherwise. Method 700 is implemented as a set of operations, such as operations 702 through 728. Further, method 700 is discussed with reference to FIGS. 4-6 and 8-28 to assist in the understanding of method 700.

In some embodiments, CHMWO method 700 describes process tasks of WO creation. In some embodiments, workflow is updated according to ongoing task execution in the WO. In some embodiments, CHMWO method 700 describes the task, execution, and approval by parties involved in the process. In some embodiments, the tasks of a CHMWO include coverage hole acceptance task, coverage hole optimization task (including planned eNB monitoring task), coverage hole optimization validation task, new site requisition task, and new site requisition validation task.

With reference to FIGS. 5 and 6, at operation 702 of method 700, a CHMWO is created by a PWO requestor as part of a coverage hole acceptance task. A PWO administrator assigns the CHMWO to the PWO requestor of the same geographic area (e.g., district) for which the CHMWO was created.

With reference to FIG. 8, the assignment is visualized with GUI 800. GUI 800 is configured to display a WO by pointing and clicking the WOs from a list of WOs, such as list of WOs 601 in FIG. 6. Point and click are the actions of a user moving a pointer to a certain location on a screen (pointing) and then pressing a button on a mouse, usually the left button (click), or another pointing device. Point and click is used with several input devices varying from mouses, touch pads, TrackPoint, joysticks, scroll buttons, and roller balls. User interfaces (UIs), for example graphical user interfaces (GUIs), are sometimes described as point-and-click interfaces, often to suggest ease of use, requiring that the user simply point to indicate their wishes. The interface is controlled through the mouse (or some other means such as a stylus), with little or no input from the keyboard, as with many GUIs.

GUI 800 displays the WO identifier 802, task list 804, and WO general information 806. WO general information 806 includes a WO category 808, polygon ID 808, template name 811, coverage hole area 812, work order creation date 814, due date 816, and work order status 818.

Task list 804 displays information regarding a coverage hole acceptance subtask 832 such as task status 820, task ID 822, task name 824, assigned to 826, last modified 828, and task completion 830.

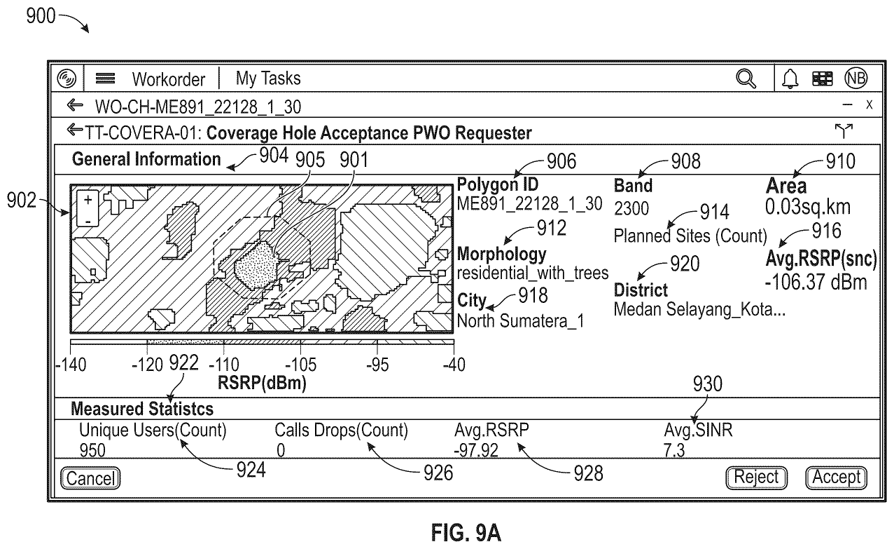

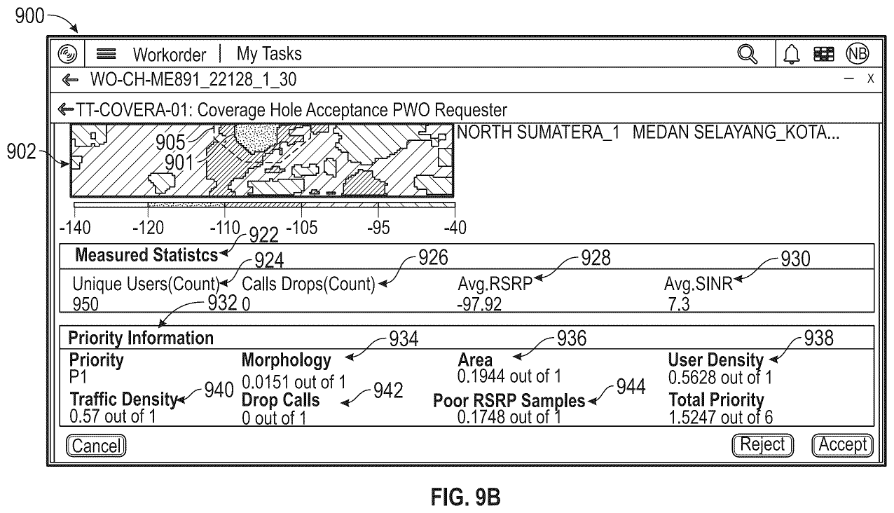

In response to a user clicking subtask 832, GUI 900 (FIGS. 9A & 9B) is displayed and map 902 is visualized displaying coverage hole 901. Along with map 902, general information 904 is further visualized such as polygon ID 906 (from polygon 905), frequency band 908, area of coverage hole 910, morphology (what does the area consist of) 912, planned site counts (how many planned cell sites for the area) 914, average RSRP 916 (e.g., smart network coverage (SNC), which is an additional RSRP layer created by superimposing network samples (discussed with reference to FIG. 2) over smaller coverage layers to obtain near actual network footprints), and geography such as city 918 and District 920. GUI 900 further provides measured statistics 922 information of a coverage hole such as unique users (non-repetitive) 924, call drop counts 926, average RSRP 928, and average signal to noise plus interference ratio (SINR) 930.

Additionally, GUI 900 (FIG. 9B) further provides priority factor information 932 of coverage holes and coverage hole priority. In priority factors, priority factor information 932 shows the values of priority factors like morphology 934, area 936, user density 938, traffic density 940, drop calls 942, and poor RSRP samples 944. With reference to the priority factor information 932 each of the measurements shown are based upon a max of 1 scale. That is 1 represents the maximum amount for each measurement and zero represents the minimum amount for each measurement. For example, if drop call 942 was measuring 1 of 1, this represents all calls were dropped and a measurement of 0 out of 1 represents no calls were dropped. Process flows from operation 702 to operation 704.

At operation 704 of method 700, the PWO requester accepts or rejects the coverage hole acceptance subtask, such as subtask 832. In response to the PWO requester's acceptance of the subtask (“ACCEPT” branch of block 704), the current task and subtask is complete, and process flows to operation 706 where a new task, coverage hole optimization is created and assigned to the PWO requester.

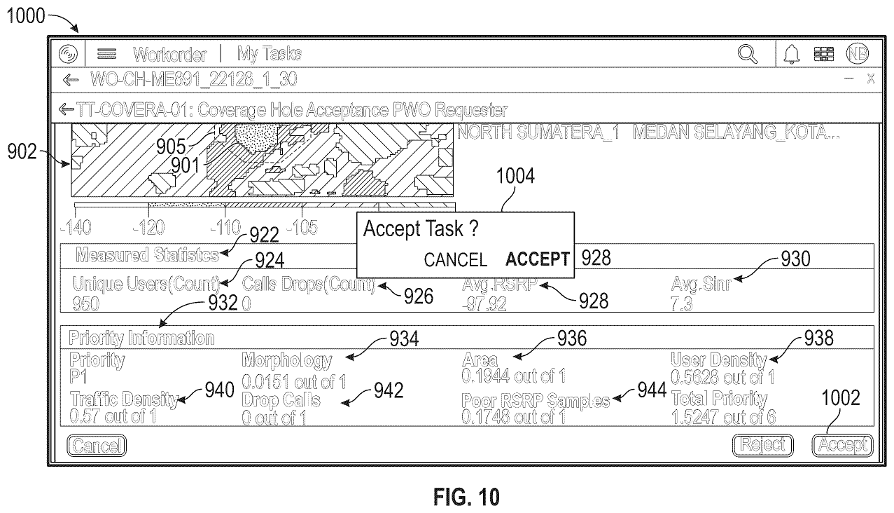

In FIG. 10, at GUI 1000, the PWO requester accepts the subtask by clicking on user input field 1002 which displays pop-up box 1004 for confirmation. In response to the PWO requestor rejecting the coverage hole acceptance subtask (“REJECT” branch of block 704), operation flows to operation 708 where a second subtask, coverage hole acceptance PWO approver is created and assigned to a PWO approver of the same geography.

At operation 710 of method 700, the PWO approver accepts or rejects the second subtask of coverage hole acceptance task. In some embodiments, the PWO approver is selecting a new PWO requester. In some embodiments, the PWO approver is accepting the task as a responsibility. In some embodiments, there are several tasks assigned to one PWO which are being executed sequentially by each individual. In response to the PWO approver accepting the subtask (“ACCEPT” branch of block 710), process flows to operation 706 where the current task and subtask is complete and new a task, coverage hole optimization is created and assigned to a PWO requester.

In response to the PWO approver rejecting the second coverage hole acceptance subtask (“REJECT” branch of block 710), process flows to operation 712 where a third subtask, coverage hole acceptance PWO admin, is created and assigned to PWO admin of the same geography at operation.

At operation 712 of method 700, a PWO admin accepts or rejects the third subtask of coverage hole acceptance task. In response to the PWO admin accepting the third subtask (“ACCEPT” branch of block 712), process flows to operation 706 where the current task and subtask are completed and a new task, coverage hole optimization is created and assigned to a PWO requester. In some embodiments, the assignment is to the same PWO requester. In some embodiments, the assignment goes to a new PWO requester.

In response to the PWO admin rejecting the third coverage hole acceptance subtask (“REJECT” branch of block 712), process flows to operation 714 and the current subtask and the task are completed, and the status of WO is completed and closed at operation 714. In some embodiments, the coverage hole is unable to be optimized, such as the coverage hole being within a restricted zone, or the coverage hole is not a business concern (covered by an SLA), or some other reason within the scope of the present disclosure.

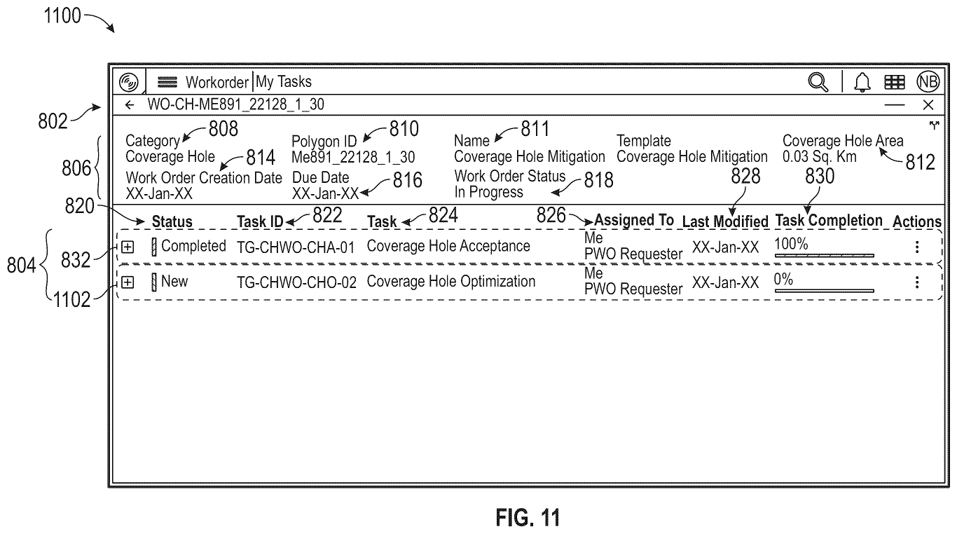

With reference to FIG. 11, at operation 706 of method 700, GUI 1100 displays a coverage hole optimization task 1102 displayed underneath coverage hole acceptance task 832 (e.g., shown as completed in task completion status 830). The second task name of CHMWO is coverage hole optimization task 1102 and is assigned to a PWO requester of the same geography.

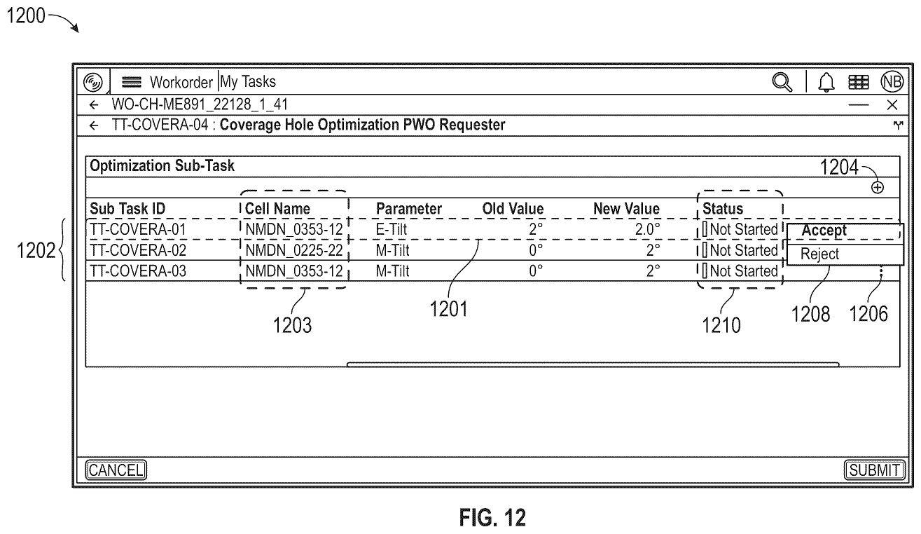

With reference to FIG. 12, in response to a user clicking on the coverage hold optimization task 1102, GUI 1200 displays optimization sub tasks.

Coverage hole optimization subtask GUI displays defaults a subtask 1201 to e-tilt parameters for the cell or cells 1203 which are recommended by a mitigation algorithm. In some embodiments, the PWO requester creates a request for e-tilt (RET) WO for a cell which is used to mitigate the coverage hole by changing electrical tilt parameter values.

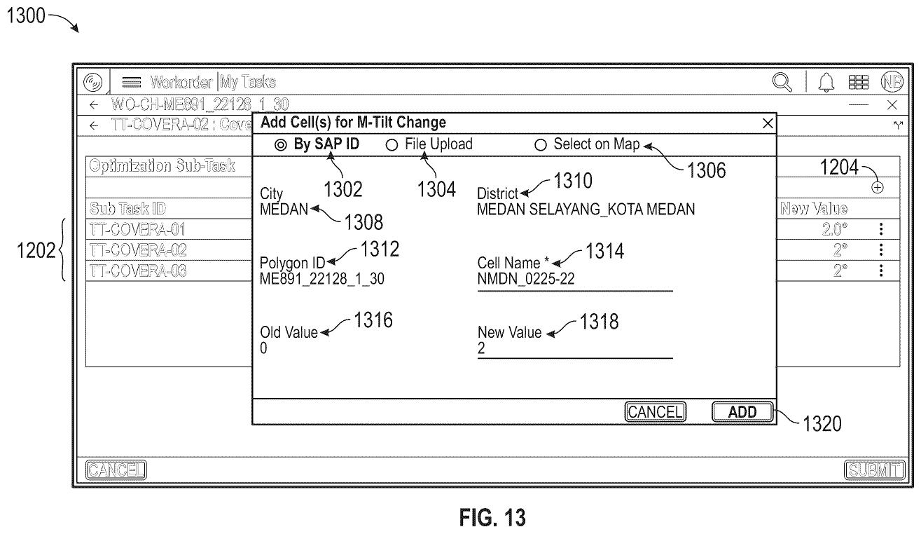

GUI 1200 provides an add cell functionality to mitigate coverage holes. Other cells are configured to be added to the optimization sub-task by clicking+icon 1204. In response to clicking on+icon 1202, a drop-down window displays parameters like e-tilt, m-tilt, antenna height, and azimuth. In some embodiments, in response to a user clicking on one of these parameters, GUI 1300 is displayed with add cell options like by sap ID 1302, file upload 1304, and select on map 1306. In some embodiments, the by sap ID window is selected (as shown in FIG. 13) by default.

A PWO requester is able to add a new cell using different methods, such as by SAP ID (service access point is an identifying label for network endpoints used in open systems interconnection (OSI) networking), file upload, and selecting the cell from a map.

In FIG. 13, GUI 1300 is a SAP ID window and provides a city input field 1308, district input field 1310, polygon ID input field 1312, cell name drop-down input field 1314, and old value 1316 of the parameter for which user wants to add a new cell (e.g., e-tilt, m-tilt, antenna height, and azimuth). In the cell name drop-down it provides a cell list which falls within that district along with an old value according to parameter selection.

In response to selecting a cell from cell name drop-down 1314, a user provides new value 1318 according to old value 1316 and clicks on the add user input field 1320. In response to clicking add user input field 1320 a new cell within subtask list 1202 is created.

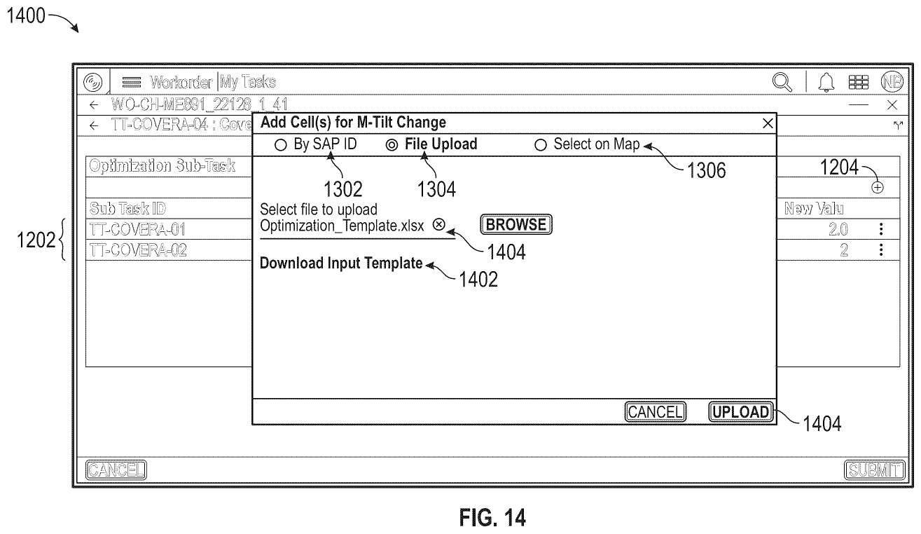

In FIG. 14, in response to selecting file upload, GUI 1400 is displayed and the user downloads the input template by clicking on download input template user selection field 1402. In some embodiments, the template is an excel template where a user provides a city, district, polygon Id, cell name, and new value corresponding to the cell's old value according to parameter selection. In response to entering the required details in the template and uploading the template, through user input field 1404, the corresponding cell within subtask list 1202 is created. In some embodiments, a user can add multiple cells within the same excel template.

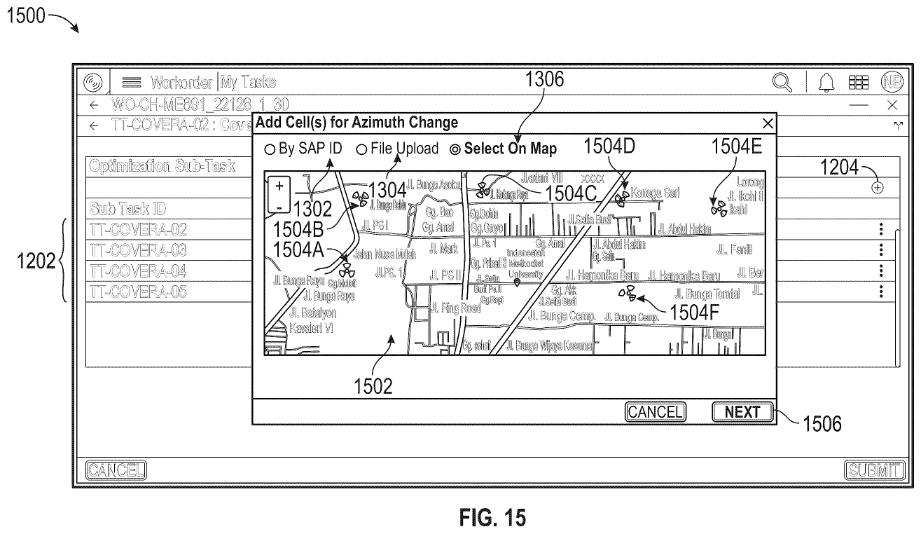

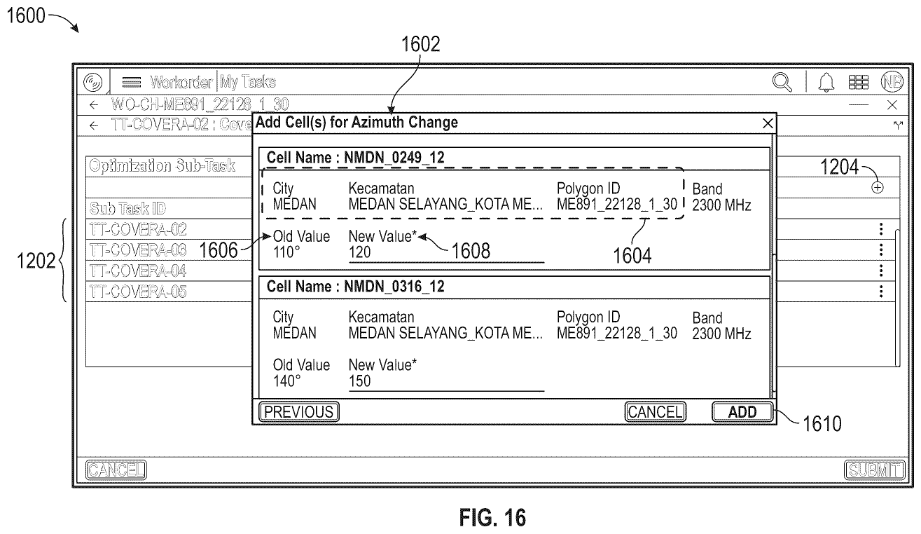

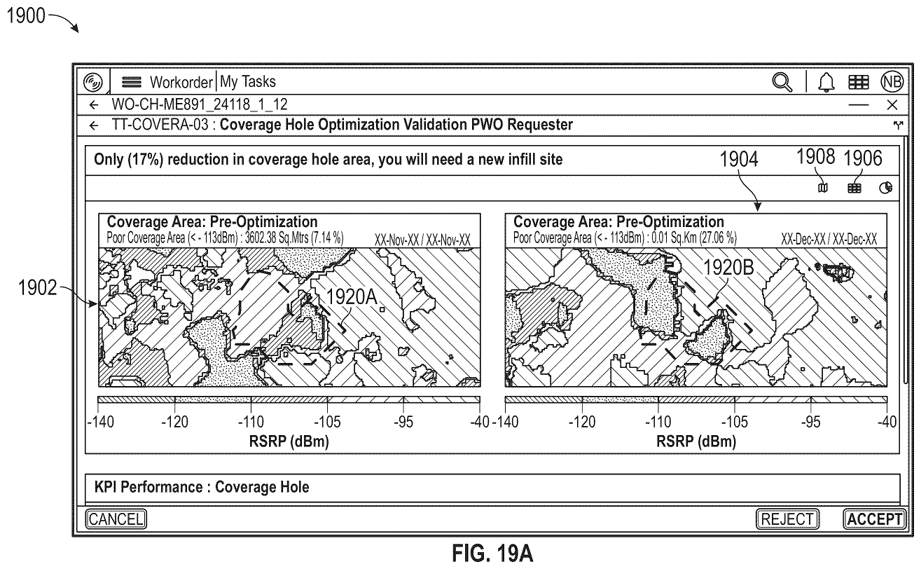

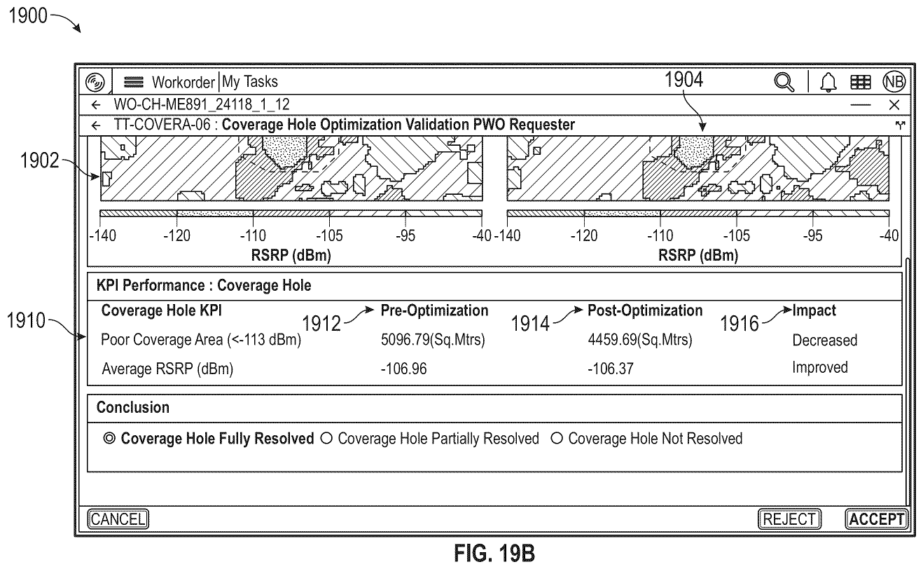

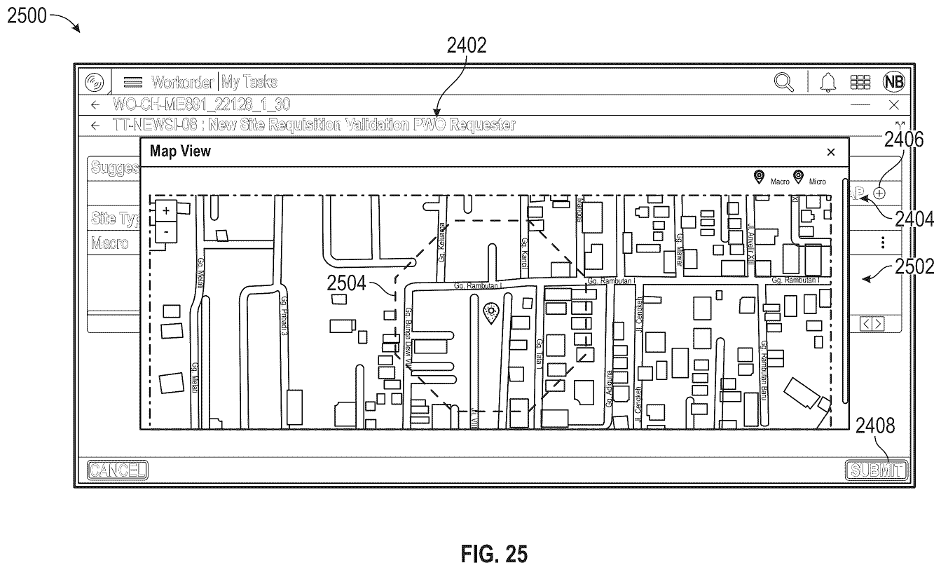

In FIG. 15, in response to selecting select on map option, GUI 1500 is displayed and a map 1502 is provided with coverage holes (e.g., polygon 905 of FIG. 9A and coverage holes 1920A and 1920B of FIG. 19A and 2504 of FIG. 25) and candidate cells 1504A, 1504B, 1504C, 1504D, 1504E and 1504F. The user clicks on a candidate cell located on map 1502 which is then taken into consideration to mitigate the coverage hole. In response to the user clicking a candidate cell on map 1502, the clicked cell is highlighted and the next user selection field 1506 is enabled. In response to clicking next user selection field 1506 GUI window 1600 (FIG. 16) is displayed where the clicked cell name 1602 is provided with geographic details 1604 and old value 1606 of the selected parameter for that cell. The user provides a new value 1608 and clicks on an add user input field 1610 and that cell is created in subtask list 1202.

Returning to FIG. 12, in response to the user clicking a menu user input field 1206 for default subtask (e.g., of parameter e-tilt subtask 1201) from subtask list 1202, accept and reject options are presented in a pop-up window 1208. In response to the user clicking accept, a RET WO is created for that cell and status 1210 of that cell changes from not started to in progress. In response to completion of the RET WO for that cell then status 1210 is changed from in progress to completed.

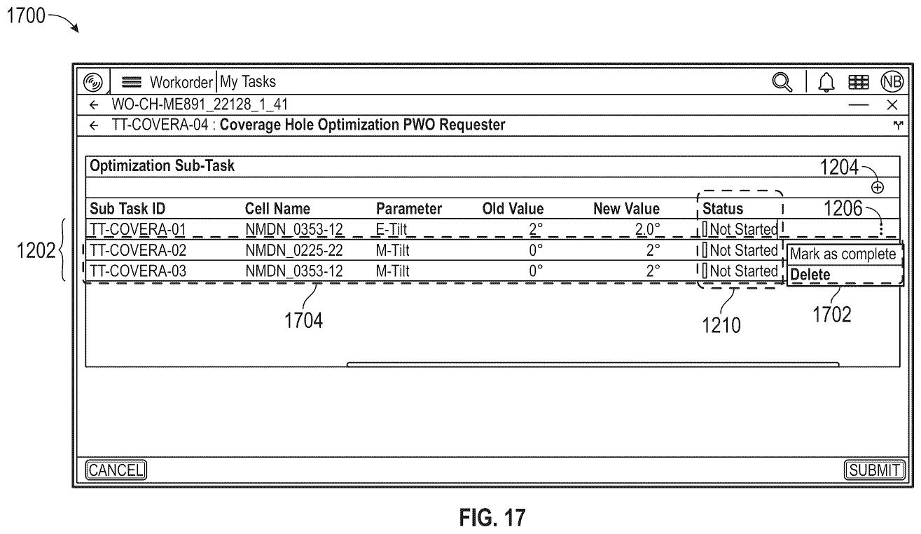

In FIG. 17, in response to clicking a menu button 1206 of the non-default or newly added cell (e.g., of parameter m-tilt, antenna height, or azimuth) shown in box 1704, options appear in pop-up box 1702 as mark as complete and delete.

In some embodiments, conditions are met to enable submission to complete the coverage hole optimization task. In some embodiments, in response to the status of the default or newly added subtask of the cell being completed. In some embodiments, there is no subtask available or added. In some embodiments, the user rejects all the default subtask (e.g., of parameter e-tilt) and status of the default subtasks is selected as rejected. Process flows from operation 706 to operation 708.

At operation 708 of method 700, in response to the completion of coverage hole optimization task at operation 706, then a new task, namely coverage hole optimization validation task is created. In some embodiments, coverage hole optimization validation includes subtasks. Process flows from operation 708 to operation 710.

At operation 710 of method 700, the PWO requester and PWO approver validate the actions performed by PWO requester in the coverage hole optimization task as discussed in operation 706.

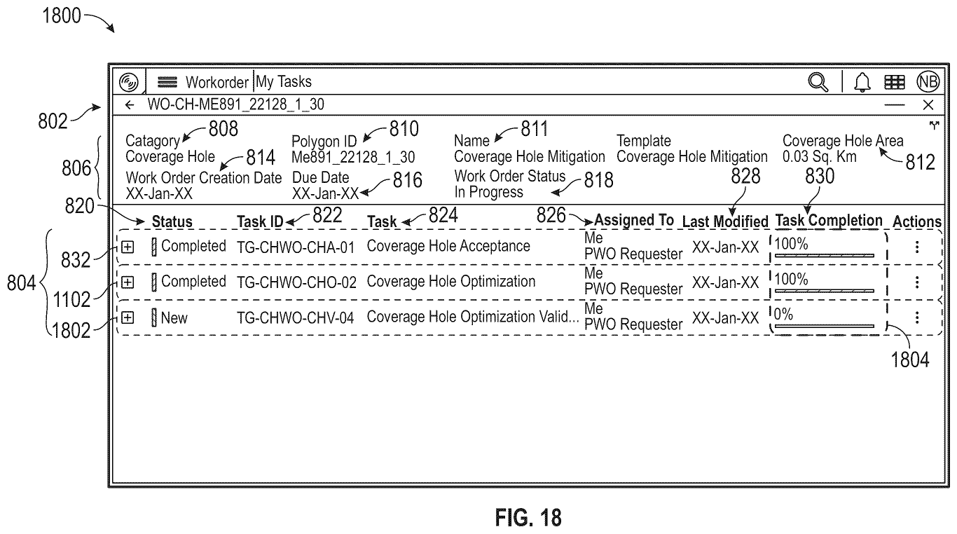

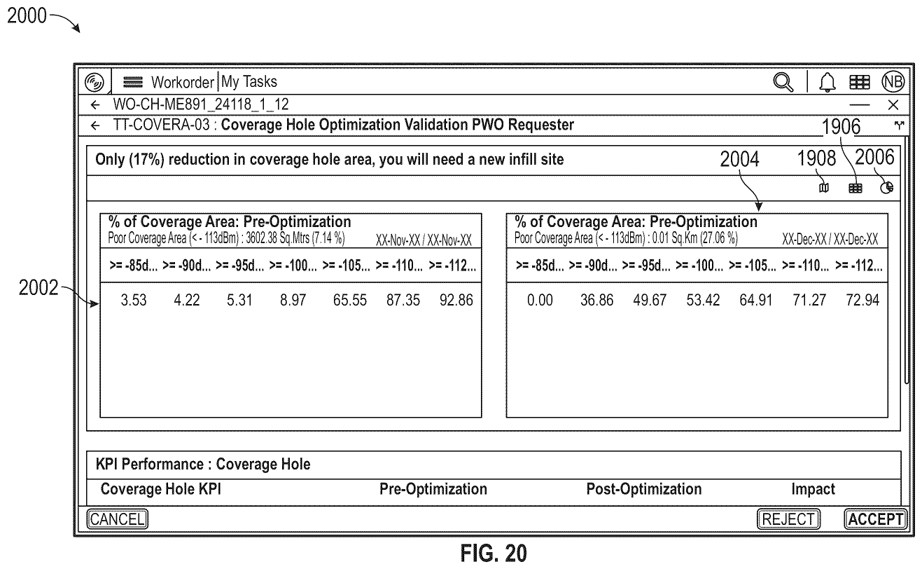

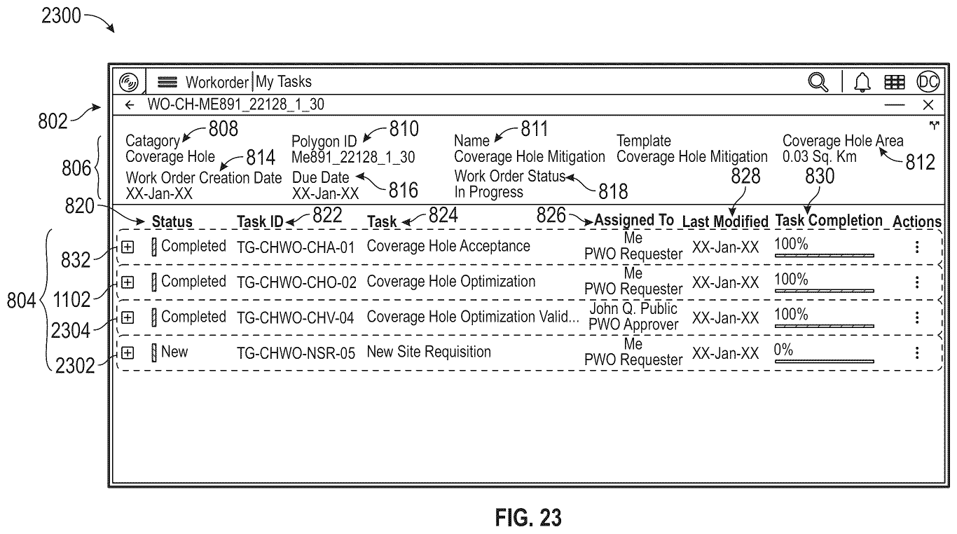

In some embodiments, the coverage optimization validation task is broken into two sub-tasks of coverage hole optimization validation PWO requester 1802 and coverage hole optimization validation PWO approver 2304 (FIG. 23). With reference to FIG. 18, GUI 1800 displays coverage hole optimization validation task 1802 assigned to the PWO requester of the same geography. In some embodiments, the PWO requester validates actions taken by the PWO requester in operation 706 in operation 710. In some embodiments, within subtask 1802, window remarks are available for the coverage hole based on progress within task completion status bar 1804. Further, Further, progress is observed with reference to status 1210 (FIG. 17) and post comparison table 2004 (FIG. 20).

In FIG. 19A, a user clicks on subtask 1802 and GUI 1900 is displayed. A pre-optimization map 1902 and post-optimization map 1904 view appears which displays improvement in coverage hole mitigation by comparing coverage hole generated SNC and current SNC. In a non-limiting example, coverage hole 1920A within pre-optimization map 1902 is compared with coverage hole 1920B within post-optimization map 1904. A user toggles to a table view by clicking a toggle user selection field 1906 next to map view toggle user selection field 1908.

In FIG. 19B, in response to scrolling down GUI 1900 displays KPI performance table 1910. KPI performance 1910 displays KPI values in the form of pre (1912) and post (1914) optimization and impact (1916).

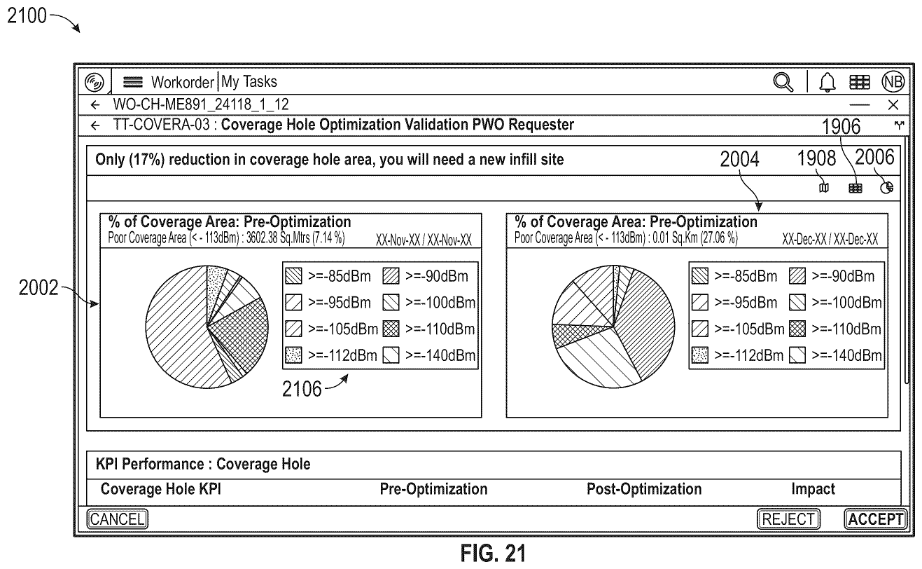

In FIG. 20, a table view GUI 2000 displays a pre (2002) and post (2004) comparison tables showing poor coverage area values at different RSRP ranges in pre and post optimization comparison. In response to a user clicking on pie chart user selection field 2006, a user is present with GUI 2100 (FIG. 21) which is a pie chart view. GUI 2100 displays pre (2102) and post (2104) optimization in the form of a pie chart and further provides a legend 2106 and filter.

In operation 710 of method 700, the PWO requester chooses to accept or reject the first validation subtask. In response to accepting the subtask (“ACCEPT” branch of block 710), process flows to operation 712. At operation 712 of method 700, the first validation subtask is completed and new subtask, namely, coverage hole optimization validation PWO approver is created and assigned to a PWO approver of the same geography.

In response to rejection of the first validation subtask (“REJECT” branch of block 710), process flows to operation 706. The validation task and subtask are completed and the process is sent back to operation 706 where coverage hole optimization status is reset to in progress and the PWO requester performs additional actions to remedy the coverage hole.

At operation 712 of method 700, the second validation subtask is activated and assigned to the PWO approver. The PWO approver is presented with GUIs similar to GUIs 1800, 1900, 2000, and 2100, where the approver determines the effectiveness of the optimization at operation 706. The PWO approver GUIs are omitted from this discussion for purposes of efficiency and reducing repetitive material. Process flows from operation 712 to operation 714.

At operation 714 of method 700, the PWO approver validates the actions performed in the optimization task of operation 706 and approves the second subtask. Further, the PWO approver accesses and closes the work order (“ACCEPT” branch of block 714) at operation 716, or requests a new site based on the coverage hole progress (“ACCEPT (WITH NEW SITE REQUEST)” branch of block 714) at operation 718. In response to the PWO approver rejecting the optimization (“REJECT (WITH REASON)” branch of block 714) process flows back to operation 706 for additional optimization.

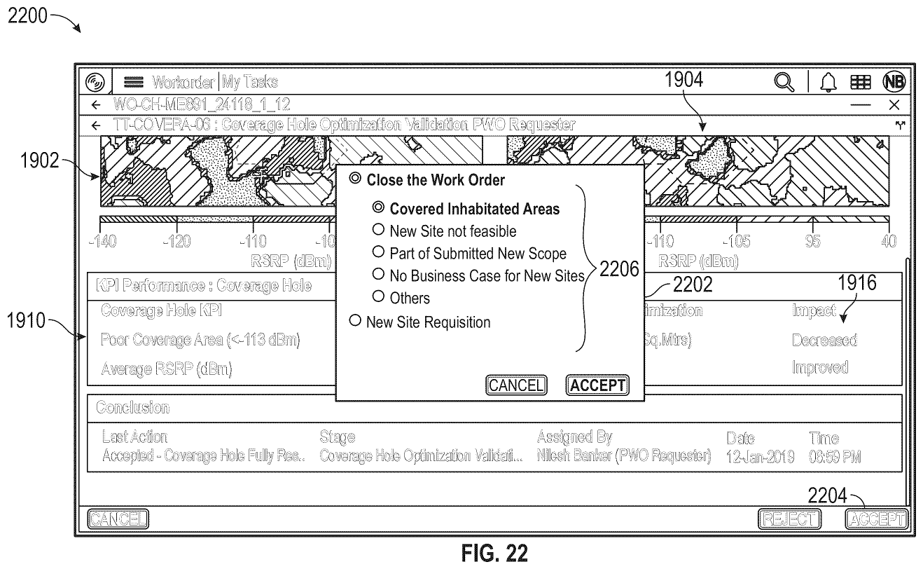

In FIG. 22, GUI 220 presents pop-up window 2202 in response the PWO approver clicking accept user selection field 2204 several options 2206 appear including close the work order or request new site.

In FIG. 23, in response to selecting request new site (“ACCEPT (WITH NEW SITE REQUEST)” branch of block 714), process flows from operation 714 to operation 718 where GUI 2300 indicates the current subtask and task 1802 are completed and new task New Site Requisition 2302 is created and assigned to a PWO requester of the same geography.

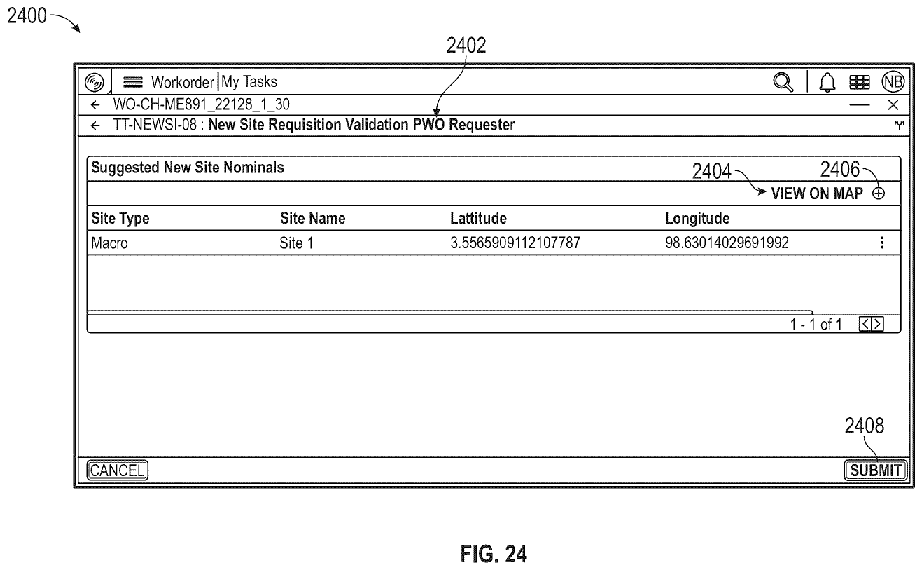

In FIG. 24, the New Site Requisition task 2302 includes, as shown in GUI 2400, one subtask 2402 assigned to the PWO requester of the same geography. In some embodiments, the name of subtask 2402 is New Site Requisition PWO requester. In some embodiments, subtask 2402 includes new site nominal defaults (e.g., a latitude and longitude) which are suggested for coverage through the mitigation algorithm.

In FIG. 25, a user viewing GUI 2500, visualizes the default site on map 2502 also by clicking on view on map user selection button 2404 (FIG. 24). The PWO requester has access to add new sites to mitigate one or more coverage holes, such as coverage hole 2504. In FIG. 24, the PWO requester adds a new site by clicking on user selection ‘+’ icon 2406 at the top right corner of GUI 2400. Further, the PWO requester adds new site details such as latitude, longitude, name, and site type (e.g., macro/micro). In some embodiments, rows of newly added sites and nominal settings are created and the PWO requester has access to delete the newly added and defaults sites. Further, the PWO requester views the newly added sites on a map, such as map 2502, by clicking on view on Map button 2406.

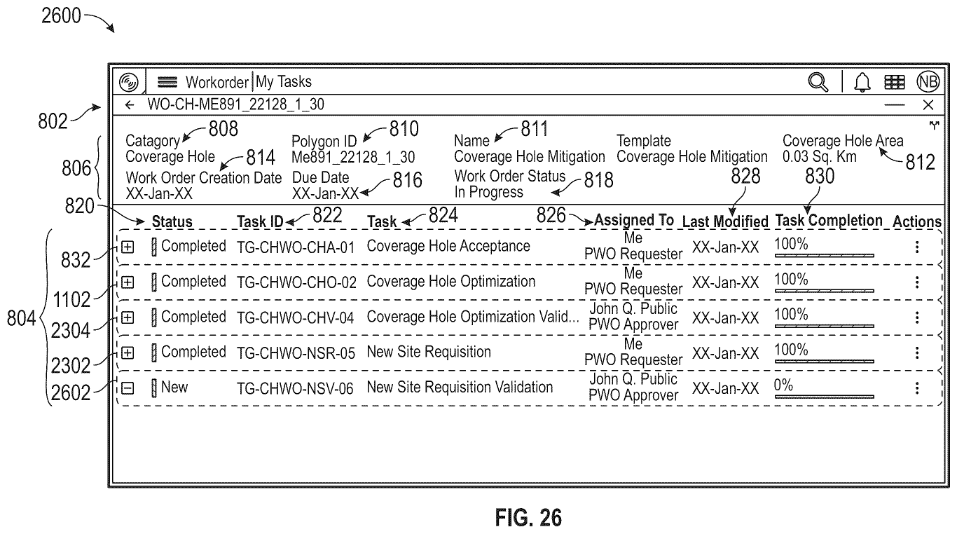

In FIG. 26, shown in GUI 2600, in response to clicking the user selection submit button 2408 (FIG. 24) then current task 2302 and subtask are completed and a new task New Site Requisition Validation task 2602 is created. In New site Requisition Validation task 2602 the new site's nominal settings, which are submitted in New Site Requisition task 2302 by PWO requester, are validated by the PWO approver (operation 720 of method 700) and PWO admin approver (operation 724 of method 700).

In operation 722 of method 700, in response to PWO approver rejecting the new site requisition (“REJECT” branch of block 722), process flows from operation 722 to operation 718 where the PWO requester is requested to modify the new site requisition. In response to PWO approver accepting the new site requisition (“ACCEPT” branch of block 722), process flows from operation 722 to operation 724 where the PWO admin is requested to validate the new site requisition.

In operation 726 of method 700, in response to PWO admin rejecting the new site requisition (“REJECT” branch of block 726), process flows from operation 726 to operation 718 where the PWO requester is requested to modify the new site requisition. In response to PWO admin accepting the new site requisition (“ACCEPT” branch of block 722), process flows from operation 726 to operation 728 where the work order is completed.

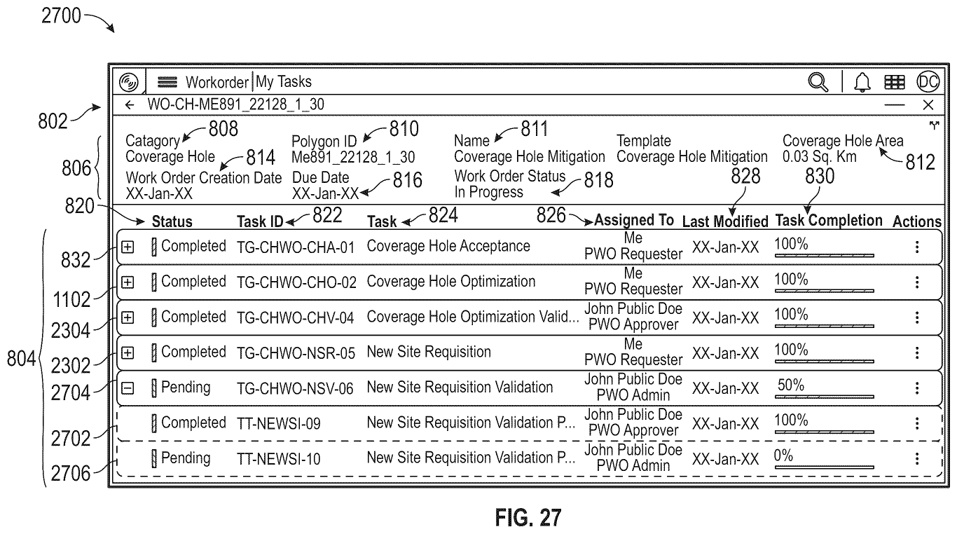

In FIG. 27, in some embodiments, GUI 2700 displays different level approvals and validation, there are two sub-task of New Site Requisition Validation task 2602; New Site Requisition Validation PWO approver 2702 and New Site Requisition Validation PWO admin 2704.

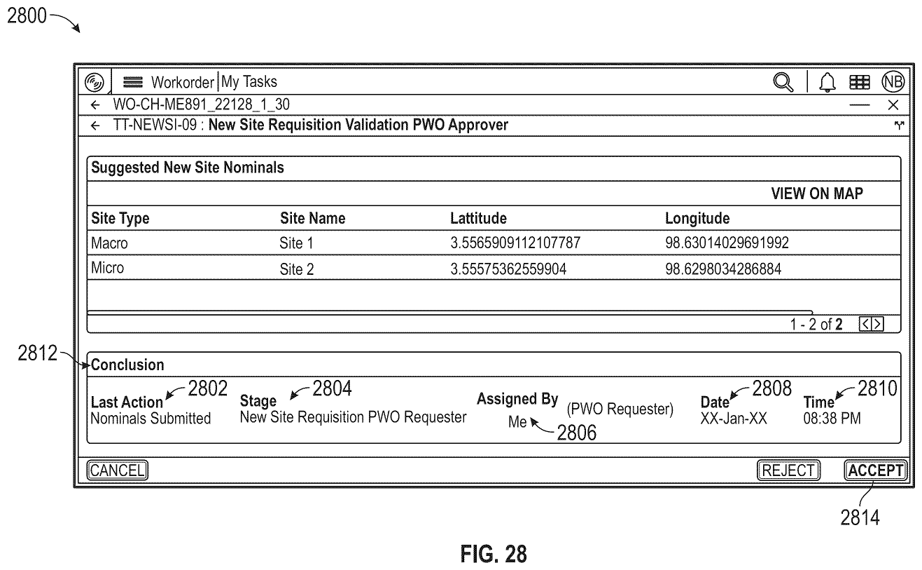

In FIG. 28, in some embodiments, the first subtask of New Site Requisition validation task 2602 is assigned to the PWO approver of the same geography. The PWO approver has access to view the default sites and newly added sites on the map. GUI 2800 displays previous task information such as the last action 2802, stage 2804, assigned by 2806, date 2808, and time 2810 in conclusion box 2812.

In response to clicking user selection accept button 2814 then current subtask 2702 is completed and new subtask namely New Site Requisition Validation PWO admin 2706 is activated and assigned to PWO admin of the same geography for further approval process.

In some embodiments, second subtask of New Site Requisition Validation task 2706 is assigned to the PWO admin of the same geography. The PWO admin has access to view the sites nominal settings on a map, such as map 2502, by clicking on view on Map button, similar to view on map button 2404. In a conclusion box, similar to conclusion box 2812, the previous subtask information with last actions which were validated by PWO approver user as displayed. In response to clicking a submit button then the current task 2702 and subtask 2706 are completed and with this, the main status of work order is further completed.

FIG. 29 is a block diagram of a coverage hole mitigation E2E work order (CHM E2E WO) processing circuitry 2900 in accordance with some embodiments. In some embodiments, CHM E2E WO processing circuitry 2900 is a general-purpose computing device including a hardware processor 2902 and a non-transitory, computer-readable storage medium 2904. Storage medium 2904, amongst other things, is encoded with, i.e., stores, computer program code 2906, i.e., a set of executable instructions such as a mitigation algorithm, or method 700. Execution of instructions 2906 by hardware processor 2902 represents (at least in part) a coverage hole mitigation E2E work order application which implements a portion, or all the methods described herein in accordance with one or more embodiments (hereinafter, the noted processes and/or methods).

Processor 2902 is electrically coupled to a computer-readable storage medium 2904 via a bus 2908. Processor 2902 is further electrically coupled to an I/O interface 2910 by bus 2908. A network interface 2912 is further electrically connected to processor 2902 via bus 2908. Network interface 2912 is connected to a network 2914, so that processor 2902 and computer-readable storage medium 2904 connect to external elements via network 2914. Processor 2902 is configured to execute computer program code 2906 encoded in computer-readable storage medium 2904 to cause CHM E2E WO processing circuitry 2900 to be usable for performing a portion or all the noted processes and/or methods. In one or more embodiments, processor 2902 is a central processing unit (CPU), a multi-processor, a distributed processing system, an application specific integrated circuit (ASIC), and/or a suitable processing unit.

In one or more embodiments, computer-readable storage medium 2904 is an electronic, magnetic, optical, electromagnetic, infrared, and/or a semiconductor system (or apparatus or device). For example, computer-readable storage medium 2904 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 2904 includes a compact disk-read only memory (CD-ROM), a compact disk-read/write (CD-R/W), and/or a digital video disc (DVD).

In one or more embodiments, storage medium 2904 stores computer program code 2906 configured to cause CHM E2E WO processing circuitry 2900 to be usable for performing a portion or all the noted processes and/or methods. In one or more embodiments, storage medium 2904 further stores information, such as a mitigation algorithm which facilitates performing a portion or all the noted processes and/or methods.

CHM E2E WO processing circuitry 2900 includes I/O interface 2910. I/O interface 2910 is coupled to external circuitry. In one or more embodiments, I/O interface 2910 includes a keyboard, keypad, mouse, trackball, trackpad, touchscreen, and/or cursor direction keys for communicating information and commands to processor 2902.

CHM E2E WO processing circuitry 2900 further includes network interface 2912 coupled to processor 2902. Network interface 2912 allows CHM E2E WO processing circuitry 2900 to communicate with network 2914, to which one or more other computer systems are connected. Network interface 2912 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, is implemented in two or more CHM E2E WO processing circuitry 2900.

CHM E2E WO processing circuitry 2900 is configured to receive information through I/O interface 2910. The information received through I/O interface 2910 includes one or more of instructions, data, design rules, and/or other parameters for processing by processor 2902. The information is transferred to processor 2902 via bus 2908. CHM E2E WO processing circuitry 2900 is configured to receive information related to UI 2922 through I/O interface 2910. The information is stored in computer-readable medium 2904 as user interface (UI) 822.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some embodiments, a method includes receiving a coverage hole mitigation work order (CHMWO) created by a project work order (PWO) administrator; receiving assignment of the CHMWO from the PWO administrator to a PWO requester that is included in a geographic location of the CHMWO; receiving coverage hole optimization for the CHMWO from the PWO requester; and closing the CHMWO in response to the coverage hole optimization being validated.

In some embodiments, the method further includes in response to the PWO requester accepting the assignment of the CHMWO, generating a coverage hole optimization work order; and assigning the coverage hole optimization work order to the PWO requester.

In some embodiments, the PWO requester is a first PWO requester, the method further including in response to the PWO requester rejecting the assignment of the CHMWO, assigning the CHMWO to a PWO approver; in response to the PWO approver accepting the assignment of the CHMWO, generating a coverage hole optimization work order; and assigning the coverage hole optimization work order to a second PWO requester.

In some embodiments, the method further includes in response to the PWO approver rejecting the assignment of the CHMWO, assigning the CHMWO to the PWO administrator; in response to the PWO administrator accepting the assignment of the CHMWO, generating the coverage hole optimization work order; assigning the coverage hole optimization work order to the second PWO requester; and in response to the PWO administrator rejecting the assignment of the CHMWO, closing the CHMWO.

In some embodiments, the receiving coverage hole optimization for the CHMWO from the PWO requester includes receiving a default e-tilt for a first cell created by a mitigation algorithm; or receiving a modified e-tilt for the first cell from the PWO requester; or receiving a second cell and parameters for the second cell to be used to mitigate a coverage hole.

In some embodiments, the method further includes receiving the parameters for the second cell through one of: receiving a service access point (SAP) ID; receiving a file upload; or selecting the second cell from a graphical user interface (GUI) displayed on a user interface (UI), the GUI displaying a map of the geographic location of the coverage hole.

In some embodiments, the method further includes in response to the coverage hole optimization for the CHMWO being rejected by the PWO requester, sending the coverage hole optimization back to the PWO requester to be modified; and in response to the coverage hole optimization for the CHMWO being accepted by the PWO requester, sending the coverage hole optimization to a PWO approver to be validated.

In some embodiments, the method further includes in response to the coverage hole optimization for the CHMWO being rejected by the PWO approver, sending the coverage hole optimization back to the PWO requester to be modified; in response to the coverage hole optimization for the CHMWO being accepted by the PWO approver, performing one of: closing the CHMWO; or assigning a new cell site request to the PWO requester.

In some embodiments, the method further includes receiving a new cell site requisition from the PWO requester; and sending the new cell site requisition to the PWO approver.

In some embodiments, the method further includes in response to the new cell site requisition being rejected by the PWO approver, sending the new cell site requisition back to the PWO requester to be modified; and in response to the new cell site requisition being accepted by the PWO approver, sending the new site requisition to the PWO administrator to be validated.

In some embodiments, an apparatus, includes a processor; and a memory having instructions stored thereon that, when executed by the processor, cause the processor to receive a coverage hole mitigation work order (CHMWO) created by a project work order (PWO) administrator; receive assignment of the CHMWO from the PWO administrator to a PWO requester that is included in a geographic region of the CHMWO; receive coverage hole optimization for the CHMWO from the PWO requester; and close the CHMWO in response to the coverage hole optimization being validated.

In some embodiments, the instructions further cause the processor to in response to PWO requester acceptance of the assignment of the CHMWO, generate a coverage hole optimization work order; and assign the coverage hole optimization work order to the PWO requester.

In some embodiments, the PWO requester is a first PWO requester, the instructions further cause the processor to in response to POW requester rejection of the assignment of the CHMWO, assign the CHMWO to a PWO approver; in response to PWO approver acceptance of the assignment of the CHMWO, generate a coverage hole optimization work order; and assign the coverage hole optimization work order to a second PWO requester.

In some embodiments, the instructions further cause the processor to in response to POW approver rejection of the assignment of the CHMWO, assign the CHMWO to the PWO administrator; in response to PWO administrator acceptance of the assignment of the CHMWO, generate the coverage hole optimization work order; assign the coverage hole optimization work order to the second PWO requester; and in response to the PWO administrator rejecting the assignment of the CHMWO, closing the CHMWO.

In some embodiments, the receiving coverage hole optimization for the CHMWO from the PWO requester includes receive a default e-tilt for a first cell created by a mitigation algorithm; or receive a modified e-tilt for the first cell from the PWO requester; or receive a second cell and parameters for the second cell to be used to mitigate a coverage hole.

In some embodiments, a non-transitory computer readable medium having instructions stored thereon that, when executed by a processor, cause an apparatus to receive a coverage hole mitigation work order (CHMWO) created by a project work order (PWO) administrator; receive assignment of the CHMWO from the PWO administrator to a PWO requester that is included in a geographic region of the CHMWO; receive coverage hole optimization for the CHMWO from the PWO requester; and close the CHMWO in response to the coverage hole optimization being validated.

In some embodiments, the instructions further cause the processor to in response to PWO requester acceptance of the assignment of the CHMWO, generate a coverage hole optimization work order; and assign the coverage hole optimization work order to the PWO requester.

In some embodiments, the PWO requester is a first PWO requester, the instructions further cause the processor to in response to POW requester rejection of the assignment of the CHMWO, assign the CHMWO to a PWO approver; in response to PWO approver acceptance of the assignment of the CHMWO, generate a coverage hole optimization work order; and assign the coverage hole optimization work order to a second PWO requester.

In some embodiments, the instructions further cause the processor to in response to POW approver rejection of the assignment of the CHMWO, assign the CHMWO to the PWO administrator; in response to PWO administrator acceptance of the assignment of the CHMWO, generate the coverage hole optimization work order; assign the coverage hole optimization work order to the second PWO requester; and in response to the PWO administrator rejecting the assignment of the CHMWO, closing the CHMWO.

In some embodiments, the receiving coverage hole optimization for the CHMWO from the PWO requester includes receive a default e-tilt for a first cell created by a mitigation algorithm; or receive a modified e-tilt for the first cell from the PWO requester; or receive a second cell and parameters for the second cell to be used to mitigate a coverage hole.

The foregoing outlines features of several embodiments so that those skilled in the art better understand the aspects of the present disclosure. Those skilled in the art should appreciate that they readily use the present disclosure as a basis for designing or modifying other processes and structures for conducting the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A method comprising:
receiving a coverage hole mitigation work order (CHMWO) created by a project work order (PWO) administrator;
receiving assignment of the CHMWO from the PWO administrator to a PWO requester that is included in a geographic location of the CHMWO;
receiving coverage hole optimization for the CHMWO from the PWO requester; and
closing the CHMWO in response to the coverage hole optimization being validated.

2. The method of claim 1, further comprising:
in response to the PWO requester accepting the assignment of the CHMWO, generating a coverage hole optimization work order; and
assigning the coverage hole optimization work order to the PWO requester.

3. The method of claim 1, wherein the PWO requester is a first PWO requester, the method further comprising:
in response to the PWO requester rejecting the assignment of the CHMWO, assigning the CHMWO to a PWO approver;
in response to the PWO approver accepting the assignment of the CHMWO, generating a coverage hole optimization work order; and
assigning the coverage hole optimization work order to a second PWO requester.

4. The method of claim 3, further comprising:
in response to the PWO approver rejecting the assignment of the CHMWO, assigning the CHMWO to the PWO administrator;
in response to the PWO administrator accepting the assignment of the CHMWO, generating the coverage hole optimization work order;
assigning the coverage hole optimization work order to the second PWO requester; and
in response to the PWO administrator rejecting the assignment of the CHMWO, closing the CHMWO.

5. The method of claim 1, wherein:
the receiving coverage hole optimization for the CHMWO from the PWO requester comprises:
receiving a default e-tilt for a first cell created by a mitigation algorithm; or
receiving a modified e-tilt for the first cell from the PWO requester; or
receiving a second cell and parameters for the second cell to be used to mitigate a coverage hole.

6. The method of claim 5, further comprising:
receiving the parameters for the second cell through one of:
receiving a service access point (SAP) ID;
receiving a file upload; or
selecting the second cell from a graphical user interface (GUI) displayed on a user interface (UI), the GUI displaying a map of the geographic location of the coverage hole.

7. The method of claim 1, further comprising:
in response to the coverage hole optimization for the CHMWO being rejected by the PWO requester, sending the coverage hole optimization back to the PWO requester to be modified; and
in response to the coverage hole optimization for the CHMWO being accepted by the PWO requester, sending the coverage hole optimization to a PWO approver to be validated.

8. The method of claim 7, further comprising:
in response to the coverage hole optimization for the CHMWO being rejected by the PWO approver, sending the coverage hole optimization back to the PWO requester to be modified;
in response to the coverage hole optimization for the CHMWO being accepted by the PWO approver, performing one of:
closing the CHMWO; or
assigning a new cell site request to the PWO requester.

9. The method of claim 8, further comprising:
receiving a new cell site requisition from the PWO requester; and
sending the new cell site requisition to the PWO approver.

10. The method of claim 9, further comprising:
in response to the new cell site requisition being rejected by the PWO approver, sending the new cell site requisition back to the PWO requester to be modified; and
in response to the new cell site requisition being accepted by the PWO approver, sending the new site requisition to the PWO administrator to be validated.

11. An apparatus, comprising:
a processor; and
a memory having instructions stored thereon that, when executed by the processor, cause the processor to:
receive a coverage hole mitigation work order (CHMWO) created by a project work order (PWO) administrator;
receive assignment of the CHMWO from the PWO administrator to a PWO requester that is included in a geographic region of the CHMWO;
receive coverage hole optimization for the CHMWO from the PWO requester; and
close the CHMWO in response to the coverage hole optimization being validated.

12. The apparatus of claim 11, wherein the instructions further cause the processor to:
in response to PWO requester acceptance of the assignment of the CHMWO, generate a coverage hole optimization work order; and
assign the coverage hole optimization work order to the PWO requester.

13. The apparatus of claim 11, wherein the PWO requester is a first PWO requester, the instructions further cause the processor to:
in response to POW requester rejection of the assignment of the CHMWO, assign the CHMWO to a PWO approver;
in response to PWO approver acceptance of the assignment of the CHMWO, generate a coverage hole optimization work order; and
assign the coverage hole optimization work order to a second PWO requester.

14. The apparatus of claim 13, wherein the instructions further cause the processor to:
in response to POW approver rejection of the assignment of the CHMWO, assign the CHMWO to the PWO administrator;
in response to PWO administrator acceptance of the assignment of the CHMWO, generate the coverage hole optimization work order;
assign the coverage hole optimization work order to the second PWO requester; and
in response to the PWO administrator rejecting the assignment of the CHMWO, closing the CHMWO.

15. The method of claim 1, wherein the receiving coverage hole optimization for the CHMWO from the PWO requester comprises:
receive a default e-tilt for a first cell created by a mitigation algorithm; or
receive a modified e-tilt for the first cell from the PWO requester; or
receive a second cell and parameters for the second cell to be used to mitigate a coverage hole.

16. A non-transitory computer readable medium having instructions stored thereon that, when executed by a processor, cause an apparatus to:
receive a coverage hole mitigation work order (CHMWO) created by a project work order (PWO) administrator;
receive assignment of the CHMWO from the PWO administrator to a PWO requester that is included in a geographic region of the CHMWO;
receive coverage hole optimization for the CHMWO from the PWO requester; and
close the CHMWO in response to the coverage hole optimization being validated.

17. The non-transitory computer readable medium of claim 16, wherein the instructions further cause the processor to:
in response to PWO requester acceptance of the assignment of the CHMWO, generate a coverage hole optimization work order; and
assign the coverage hole optimization work order to the PWO requester.

18. The non-transitory computer readable medium of claim 16, wherein the PWO requester is a first PWO requester, the instructions further cause the processor to:
in response to POW requester rejection of the assignment of the CHMWO, assign the CHMWO to a PWO approver;
in response to PWO approver acceptance of the assignment of the CHMWO, generate a coverage hole optimization work order; and
assign the coverage hole optimization work order to a second PWO requester.

19. The non-transitory computer readable medium of claim 18, wherein the instructions further cause the processor to:
in response to POW approver rejection of the assignment of the CHMWO, assign the CHMWO to the PWO administrator;
in response to PWO administrator acceptance of the assignment of the CHMWO, generate the coverage hole optimization work order;
assign the coverage hole optimization work order to the second PWO requester; and
in response to the PWO administrator rejecting the assignment of the CHMWO, closing the CHMWO.

20. The non-transitory computer readable medium of claim 16, wherein the receiving coverage hole optimization for the CHMWO from the PWO requester comprises:
receive a default e-tilt for a first cell created by a mitigation algorithm; or
receive a modified e-tilt for the first cell from the PWO requester; or
receive a second cell and parameters for the second cell to be used to mitigate a coverage hole.
